(19) United States
(12) Patent Application Publication
(10) Pub. No.: US 2025/0377859 A1
(43) Pub. Date: Dec. 11, 2025

(54) FUSED MULTIPLY-ADD (FMA) OPERATION USING OPERAND EXPONENT DIFFERENCES

(71) Applicant: Samsung Electronics Co., Ltd., Suwon-si (KR)

(72) Inventors: Mingu Jeong, SUWON-SI (KR); HYUNPIL KIM, SUWON-SI (KR); JONGHYUP LEE, SUWON-SI (KR)

(21) Appl. No.: 19/222,095

(22) Filed: May 29, 2025

(30) Foreign Application Priority Data
Jun. 11, 2024 (KR) 10-2024-0075826

(51) Int. Cl. G06F 7/544; G06F 5/01; G06F 7/499; G06F 7/50; G06F 7/523

(52) U.S. Cl. CPC G06F 7/5443; G06F 5/01; G06F 7/49947; G06F 7/50; G06F 7/523

(57) ABSTRACT

A fused multiply-add (FMA) circuit includes a subtractor configured to determine an exponent difference between an exponent corresponding to multiplication of a first operand and a second operand and an exponent corresponding to a third operand, a multiplier configured to multiply a mantissa corresponding to the first operand and a mantissa corresponding to the second operand to generate mantissa multiplication result, a processor configured to generate a plurality of operation results from the mantissa multiplication result and a mantissa corresponding to the third operand, based on a plurality of path circuits respectively corresponding to a plurality of predetermined exponent ranges, and a multiplexer configured to output, as an FMA operation result, a first operation result selected from among the plurality of operation results in response to the exponent difference belonging to a first exponent range among the predetermined exponent ranges.

### CROSS-REFERENCE TO RELATED APPLICATIONS

This patent application claims priority under 35 USC § 119 (a) to Korean Patent Application No. 10-2024-0075826, filed on Jun. 11, 2024, in the Korean Intellectual Property Office, the disclosure of which is incorporated by reference in its entirety herein.

### 1. TECHNICAL FIELD

One or more embodiments are directed to a method and an apparatus for performing a fused multiply-add (FMA) operation.

### 2. DISCUSSION OF RELATED ART

A fused multiply-add (FMA) operation is a single operation that performs both a multiplication and an addition. Two floating-point numbers are multiplied to generate a result and another floating-point number is added to the result with one command in the single operation. An FMA operation may be used in a field that requires a high-performance operation, such as graphics processing and signal processing. For example, a graphics processing unit (GPU), a central processing unit (CPU), or a neural processing unit (NPU) may support an FMA operation to maximize operation performance.

Multiple adders and shifters may be used to perform an FMA operation. An adder is a digital circuit that performs the addition of binary numbers. A shifter is a digital circuit that shifts the bits of a binary number to the left or to the right. However, a significant increase in the number of adders or shifters can lead to higher power consumption for an FMA operation and result in area overhead of a circuit or a chip that performs the FMA operation.

A circuit that performs an FMA operation can have multiple data paths. However, these multiple data paths may introduce an operation latency due to path selection overhead, synchronization between paths and complexity of the paths.

A fused multiply-add (FMA) circuit according to an embodiment incudes a subtractor, a multiplier, a processor and a multiplexer. The subtractor is configured to determine an exponent difference between an exponent corresponding to multiplication of a first operand and a second operand and an exponent corresponding to a third operand. The multiplier is configured to multiply a mantissa corresponding to the first operand and a mantissa corresponding to the second operand to generate a mantissa multiplication result. The processor is configured to generate a plurality of operation results from the mantissa multiplication result and a mantissa corresponding to the third operand, based on a plurality of path circuits respectively corresponding to a plurality of predetermined exponent ranges. The multiplexer is configured to output, as an FMA operation result, an operation result selected from among the plurality of operation results in response to the exponent difference belonging to an exponent range among the predetermined exponent ranges. The path circuit of the plurality of path circuits is configured to: determine a comparison result between a sign of the multiplication of the first operand and the second operand, and a sign of the third operand; determine whether an adjustment of the mantissa corresponding to the third operand is required based on the comparison result; update the mantissa of the third operand when it is determined that the adjustment is required; and provide the mantissa of the third operand.

### SUMMARY

According to an embodiment, there is provided a fused multiply-add (FMA) circuit including a subtractor configured to determine an exponent difference between an exponent corresponding to multiplication of a first operand and a second operand and an exponent corresponding to a third operand, a multiplier configured to multiply a mantissa corresponding to the first operand and a mantissa corresponding to the second operand to generate a mantissa multiplication result, a processor configured to generate a plurality of operation results from the mantissa multiplication result and a mantissa corresponding to the third operand, based on a plurality of path circuits respectively corresponding to a plurality of predetermined exponent ranges, and a multiplexer configured to output, as an FMA operation result, a first operation result selected from among the plurality of operation results in response to the exponent difference belonging to a first exponent range among the predetermined exponent ranges. A first path circuit of the plurality of path circuits is configured to perform one of an increment operation or a decrement operation on the mantissa corresponding to the third operand to generate an updated mantissa, based on a comparison result between a sign corresponding to the multiplication of the first operand and the second operand and a sign corresponding to the third operand and is configured to provide one of the updated mantissa or the mantissa corresponding to the third operand, as the first operation result.

The first path circuit may be configured to generate a rounding result of an intermediate operation between the mantissa multiplication result and the mantissa corresponding to the third operand when the exponent difference is the first exponent range, generate the first operation result by increasing or decreasing the mantissa corresponding to the third operand when the exponent difference is in the first exponent range and the rounding result is rounding up, and to provide the mantissa corresponding to the third operand as the first operation result when the exponent difference is not in the first exponent range or the rounding result is rounding down.

The multiplexer may be configured to output, as the FMA operation result, a second operation result generated by a second path circuit of the plurality of path circuits based on a mantissa corresponding to the multiplication of the first operand and the second operand and the mantissa corresponding to the third operand in response to the exponent difference belonging to a second exponent range among the predetermined exponent ranges, in which the second exponent range may be greater than or equal to a first threshold value and less than a second threshold value, or greater than or equal to a third threshold value.

The second path circuit may be configured to perform a bit shift on a mantissa of an operand corresponding to an exponent having a less value among the exponent corresponding to the multiplication of the first operand and the second operand and the exponent corresponding to the third operand, based on the exponent difference.

In response to the exponent difference being greater than or equal to a fourth threshold value that is greater than the third threshold value, the multiplexer may be configured to output, as the FMA operation result, the second operation result generated by the second path circuit based on performing a sign extension on the mantissa corresponding to the third operand to generate a sign-extended mantissa so that the mantissa corresponding to the third operand corresponds to a bit number of the mantissa corresponding to the multiplication of the first operand and the second operand and performing a bit shift on the sign-extended mantissa based on a value obtained by subtracting the sign-extended mantissa from the exponent difference by a predetermined number.

In response to the exponent difference being greater than or equal to the third threshold value and less than a fourth threshold value, the multiplexer may be configured to output, as the FMA operation result, the second operation result generated by the second path circuit based on performing zero-padding on the mantissa corresponding to the third operand to generate a zero-padded mantissa and performing a bit shift on the zero-padded mantissa based on the exponent difference.

In response to the exponent difference being greater than or equal to the first threshold value and less than the second threshold value, the multiplexer may be configured to output, as the FMA operation result, the second operation result generated by the second path circuit based on performing a bit shift on the mantissa corresponding to the multiplication of the first operand and the second operand by a number of sign inversions of the exponent difference.

In response to the exponent difference belonging to a third exponent range among the plurality of predetermined exponent ranges, the multiplexer may be configured to output, as the FMA operation result, a third operation result generated by a third path circuit of the plurality of path circuits based on a mantissa corresponding to the multiplication of the first operand and the second operand and the mantissa corresponding to the third operand, in which the third exponent range is greater than or equal to a second threshold value and less than a third threshold value.

The third path circuit may be configured to perform, based on the exponent difference, a bit shift on a mantissa of an operand corresponding to a lesser value among the exponent corresponding to the multiplication of the first operand and the second operand and the exponent corresponding to the third operand to generate a bit-shifted mantissa, in which the third path circuit may include a leading one detector (LOD) configured to extract a bit position value having a bit corresponding to a value of ‘1’ and closest to a most significant bit (MSB), in an addition result of the bit-shifted mantissa and remaining mantissas and a normalize shifter configured to perform a normalization shift on the addition result based on the extracted bit position value.

The second threshold value may be greater than the first threshold value, and the third threshold value is greater than the second threshold value, in which the first threshold value and the fourth threshold value may be defined based on a bit-precision of at least one of the first to third operands.

According to an embodiment, there is provided an FMA operation method including determining an exponent difference between an exponent corresponding to multiplication of a first operand and a second operand and an exponent corresponding to a third operand, multiplying a mantissa corresponding to the first operand and a mantissa corresponding to the second operand to generate a mantissa multiplication result, generating a plurality of operation results from the mantissa multiplication result and a mantissa corresponding to the third operand, based on a plurality of path circuits respectively corresponding to a plurality of predetermined exponent ranges, and outputting, as an FMA operation result, a first operation result selected from among the plurality of operation results in response to the exponent difference belonging to a first exponent range among the predetermined exponent ranges, in which the generating of the plurality of operation results includes performing one of an increment operation or a decrement operation on the mantissa corresponding to the third operand to generate an updated mantissa, based on a comparison result between a sign corresponding to the multiplication of the first operand and the second operand and a sign corresponding to the third operand and providing one of the updated mantissa or the mantissa corresponding to the third operand, as the first operation result.

The generating of the plurality of operation results may include generating a rounding result of an intermediate operation between the mantissa multiplication result and the mantissa corresponding to the third operand when the exponent difference is in the first exponent range, generating the first operation result by increasing or decreasing the mantissa corresponding to the third operand when the exponent difference is the first exponent range and the rounding result is rounding up, and providing the mantissa corresponding to the third operand as the first operation result when the exponent difference is not in the first exponent range or the rounding result is rounding down.

The FMA operation method may further include generating a second operation result based on a mantissa corresponding to the multiplication of the first operand and the second operand and the mantissa corresponding to the third operand and outputting the generated second operation result as the FMA operation result in response to the exponent difference belonging to a second exponent range among the predetermined exponent ranges, in which the second exponent range may be greater than or equal to a first threshold value and less than a second threshold value, or greater than or equal to a third threshold value.

The generating of the second operation result may include performing a bit shift on a mantissa of an operand corresponding to an exponent having a lesser value among the exponent corresponding to the multiplication of the first operand and the second operand and the exponent corresponding to the third operand, based on the determined exponent difference.

The outputting of the generated second operation result as the FMA operation result may include performing a sign extension on the mantissa corresponding to the third operand to generate a sign-extended mantissa so that the mantissa corresponding to the third operand corresponds to a bit number of the mantissa corresponding to the multiplication of the first operand and the second operand, generating the second operation result based on performing a bit shift on the sign-extended mantissa based on a value obtained by subtracting the sign-extended mantissa from the exponent difference by a predetermined number, and outputting the generated second operation result as the FMA operation result in response to the determined exponent difference being greater than or equal to a fourth threshold value that is greater than the third threshold value.

The outputting of the generated second operation result as the FMA operation result may include performing zero-padding on the mantissa corresponding to the third operand to generate a zero-padded mantissa, generating the second operation result based on performing a bit shift on the zero-padded mantissa by the exponent difference, and outputting the generated second operation result as the FMA operation result in response to the exponent difference being greater than or equal to the third threshold value and less than a fourth threshold value.

The outputting of the generated second operation result as the FMA operation result may include generating the second operation result based on performing a bit shift on the mantissa corresponding to the multiplication of the first operand and the second operand by a number of sign inversions of the exponent difference and outputting the generated second operation result as the FMA operation result in response to the exponent difference being greater than or equal to the first threshold value and less than the second threshold value.

The FMA operation method may further include generating a third operation result by a third path circuit of the plurality of path circuits based on a mantissa corresponding to the multiplication of the first operand and the second operand and the mantissa corresponding to the third operand and outputting the generated third operation result as the FMA operation result in response to the exponent difference belonging to a third exponent range among the predetermined exponent ranges, in which the predetermined third exponent range is greater than or equal to a second threshold value and less than a third threshold value.

The generating of the third operation result may include performing a bit shift on a mantissa of an operand corresponding to a lesser value among the exponent corresponding to the multiplication of the first operand and the second operand and the exponent corresponding to the third operand to generate a bit-shifted mantissa, based on the exponent difference, extracting a bit position value having a bit corresponding to a value of ‘l’ and closest to an MSB, in an addition result of the bit-shifted mantissa and remaining mantissas, and performing a normalization shift on the addition result based on the extracted bit position value.

### BRIEF DESCRIPTION OF THE DRAWINGS

These and/or other aspects and features of the inventive concept will become apparent and more readily appreciated from the following description of embodiments, taken in conjunction with the accompanying drawings of which:

FIG. 1 illustrates a fused multiply-add (FMA) operation according to an embodiment;

FIG. 2 is a block diagram illustrating an FMA circuit that varies FMA operation paths according to a plurality of path circuits;

FIG. 3 is a flowchart illustrating an FMA operation method based on a first path circuit of an FMA circuit, according to an embodiment;

FIG. 4 is a block diagram illustrating a structure of a first path circuit, according to an embodiment;

FIG. 5 illustrates an example in which an FMA circuit selects, as an FMA operation result, a first operation result generated based on a first path circuit, according to an embodiment;

FIGS. 6A to 6C are block diagrams illustrating a structure of a second path circuit, according to an embodiment;

FIGS. 7 to 9 illustrate examples in which an FMA circuit selects, as an FMA operation result, a second operation result generated based on a second path circuit, according to an embodiment;

FIG. 10 is a block diagram illustrating a structure of a third path circuit, according to an embodiment;

FIG. 11 illustrates an example in which an FMA circuit selects, as an FMA operation result, a third operation result generated based on a third path circuit, according to an embodiment;

FIG. 12 illustrates a vector processor using an FMA circuit, according to an embodiment; and

FIG. 13 is a block diagram illustrating a configuration of an electronic device, according to an embodiment.

### DETAILED DESCRIPTION

The following description is provided to describe the example embodiments, but the scope of the example embodiments is not limited to the descriptions provided herein. Accordingly, the embodiments are not construed as limited to the disclosure and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, or similarly, the second component may be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. As used herein, “A or B,” “at least one of A and B,” “at least one of A or B,” “A, B or C,” “at least one of A, B and C,” and “A, B, or C,” each of which may include any one of the items listed together in the corresponding one of the phrases, or all possible combinations thereof.

Hereinafter, embodiments will be described in detail with reference to the accompanying drawings. When describing the embodiments with reference to the accompanying drawings, like reference numerals refer to like elements and a repeated description related thereto will be omitted.

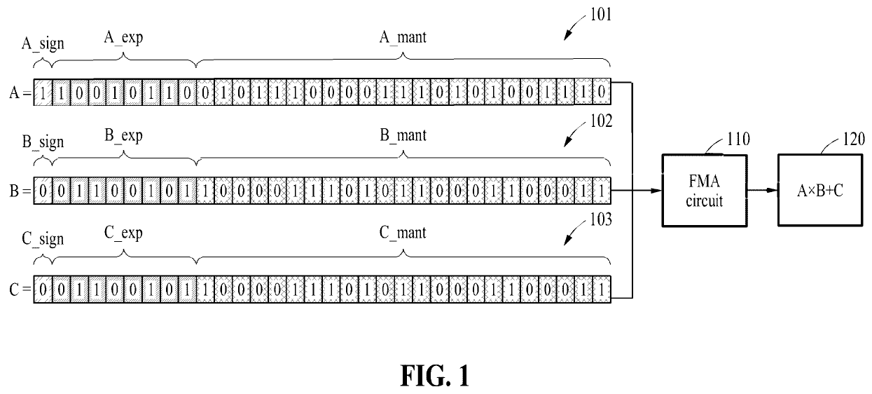

FIG. 1 illustrates a fused multiply-add (FMA) operation according to an embodiment.

An FMA circuit 110 according to an embodiment may provide an FMA operation result 120 based on a plurality of operands (e.g., a first operand 101, a second operand 102, and a third operand 103). For example, the FMA circuit 110 may receive the three operands 101, 102, and 103 as an input and may perform multiplication and addition operations on the first operand 101, the second operand 102, and the third operand 103 through a single action.

The FMA operation may multiply two floating-point numbers to a generate multiplication result and add another floating-point number to the multiplication result using a single command. The FMA operation may be referred to as, but is not limited to, a single multiply-accumulate operation, a multiply-add coupling operation, or an FMA operation.

The first operand 101, the second operand 102, and the third operand 103 may be floating-point numbers. For example, the first operand 101, the second operand 102, and the third operand 103 may have a 32-bit floating-point format (e.g., floating point (FP) 32) or a 16-bit floating-point format (e.g., brain floating point (BF) 16). FP32 and BF16 may represent a method of expressing real numbers as binary floating-point numbers. FP32 may represent a 32-bit expression method including a 1-bit sign, an 8-bit exponent, and a 23-bit mantissa. BF16 may represent a 16-bit expression method including a 1-bit sign, an 8-bit exponent, and a 7-bit mantissa. For example, operands in the FP32 format may represent a bit sequence of a total of 32 bits, and bit values of ‘0’ or ‘1’ may be stored at each bit position of the bit sequence. Hereinafter, the first operand 101, the second operand 102, and the third operand 103 of FP32 are mainly described herein. As described above, the first operand 101, the second operand 102, and the third operand 103 may include a sign bit (e.g., A_sign, B_sign, and C_sign) corresponding to a sign value, an exponent (e.g., A_exp, B_exp, and C_exp) corresponding to an exponent value, and a mantissa (e.g., A_mant, B_mant, and C_mant) corresponding to a mantissa value, respectively. For example, assuming that the first operand 101 corresponds to the decimal number of ‘−314.625,’ A_sign may be ‘l’ since a sign of the decimal number corresponding to the first operand 101 is a negative number. The decimal number ‘314.625’ may be expressed as 100111010.101₍₂₎ when ‘314.625’ is expressed in a binary number. The decimal number ‘314.625’ may be expressed as 1.00111010101×2⁸ when ‘314.625’ is expressed in a normalized expression method (e.g., 1. (mantissa bit)×2^{E}). Based on the number expressed in the normalized expression method, 10000111₍₂₎, which is obtained by converting ‘135’ obtained by adding ‘127’ corresponding to the bias of FP32 to an exponent ‘8’ of ‘2’ into a binary number, may correspond to A_exp. The normalized expression 10000111₍₂₎ (e.g., A_exp) may be derived by converting the sum of the exponent ‘8’ of base 2 and the FP32 bias of ‘127’ (resulting in ‘135’) into a binary number. In addition, in the normalized expression method, 00111010101, which is after the decimal point, may correspond to A_mant. In the same manner, the second operand 102 and the third operand 103 may be expressed in the FP32 format.

The FMA circuit 110 according to an embodiment performs an addition and multiplication based on the received first operand 101, the received second operand 102, and the received third operand 103. For example, the FMA circuit 110 may separate the sign bit (e.g., A_sign, B_sign, and C_sign), the exponent (e.g., A_exp, B_exp, and C_exp), and the mantissa (e.g., A_mant, B_mant, and C_mant) based on a bit position of each of the received first operand 101, the received second operand 102, and the received third operand 103. The FMA circuit 110 may provide the FMA operation result 120 between the first operand 101, the second operand 102, and the third operand 103 based on the separated sign bit, the separated exponent, and the separated mantissa of the first operand 101, the second operand 102, and the third operand 103. For example, the FMA circuit 110 may perform multiplication between the first operand 101 and the second operand 102 based on the sign bit, the exponent, and the mantissa, which are separated according to the bit position. For example, the FMA circuit 110 may determine a sign bit of the multiplication result based on the sign bit (e.g., A_sign and B_sign) of each of the first operand 101 and the second operand 102. For example, when the sign bit of the first operand 101 corresponds to ‘l’ and the sign bit of the second operand 102 corresponds to ‘0,’ the sign bit of the multiplication result of the first operand 101 and the second operand 102 may correspond to ‘1.’ For reference, the sign bit of ‘1’ may indicate that an operand is a negative number and the sign bit of ‘0’ may indicate that an operand is a positive number. For example, the FMA circuit 110 may determine a sign bit of the multiplication result (e.g., A×B) by performing an XOR logical operation on the sign bit of each of the first operand 101 and the second operand 102.

The FMA circuit 110 may determine an exponent of the multiplication result (e.g., A×B) based on the exponent (e.g., A_exp and B_exp) of each of the first operand 101 and the second operand 102. For example, the FMA circuit 110 may determine the exponent of the multiplication result (e.g., A×B) based on a value obtained by subtracting the bias of FP32 from a result obtained by adding, based on an adder, the exponent (e.g., A_exp) of the first operand 101 to the exponent (e.g., B_exp) of the second operand 102. For example, the FMA circuit 110 may determine the exponent of the multiplication result (A×B) by subtracting the FP32 bias from the sum of the exponents of the first operand 101 (A_exp) and the second operand 102 (B_exp), with the sum being calculated using an adder. For example, the bias of a single precision floating point (e.g., FP32) may correspond to ‘127,’ which is 2^{8(bit)-1}.

The FMA circuit 110 may determine a mantissa of the multiplication result (e.g., A×B) based on the mantissa (e.g., A_mant and B_mant) of each of the first operand 101 and the second operand 102. For example, the FMA circuit 110 may determine, to be the mantissa of the multiplication result (e.g., A×B), a result obtained by multiplying, based on a multiplier, the mantissa (e.g., A_mant) of the first operand 101 by the mantissa (e.g., B_mant) of the second operand 102. For example, the FMA circuit 110 may determine the mantissa of the multiplication result (e.g., A×B) to be 10.00001₍₂₎ when the mantissa of the first operand 101 corresponds to 1.101₍₂₎ and the mantissa of the second operand 102 corresponds to 1.01₍₂₎.

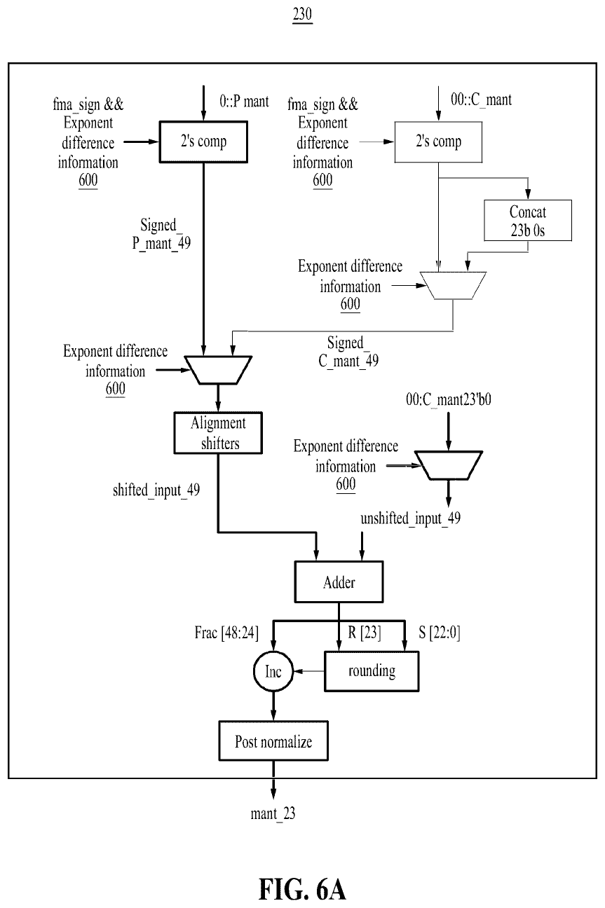

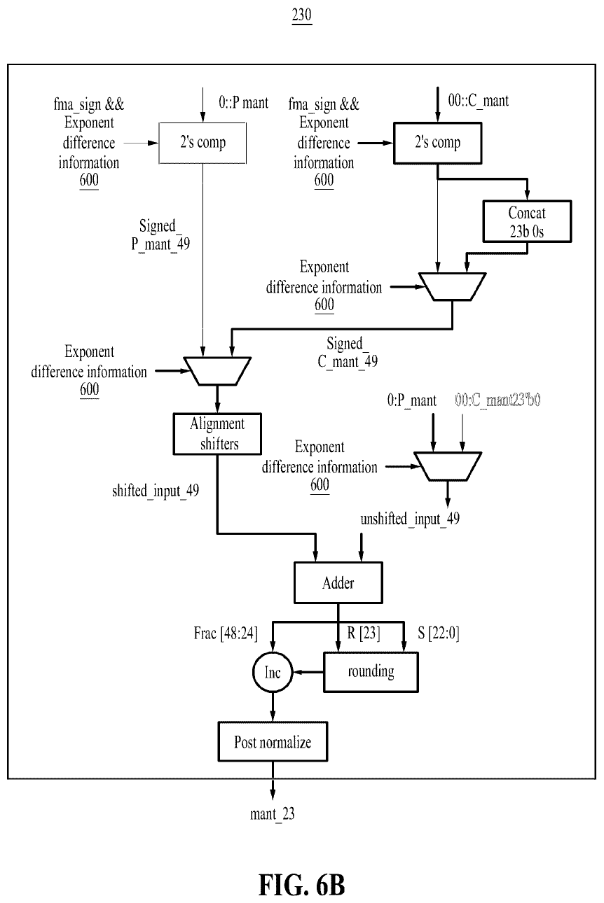

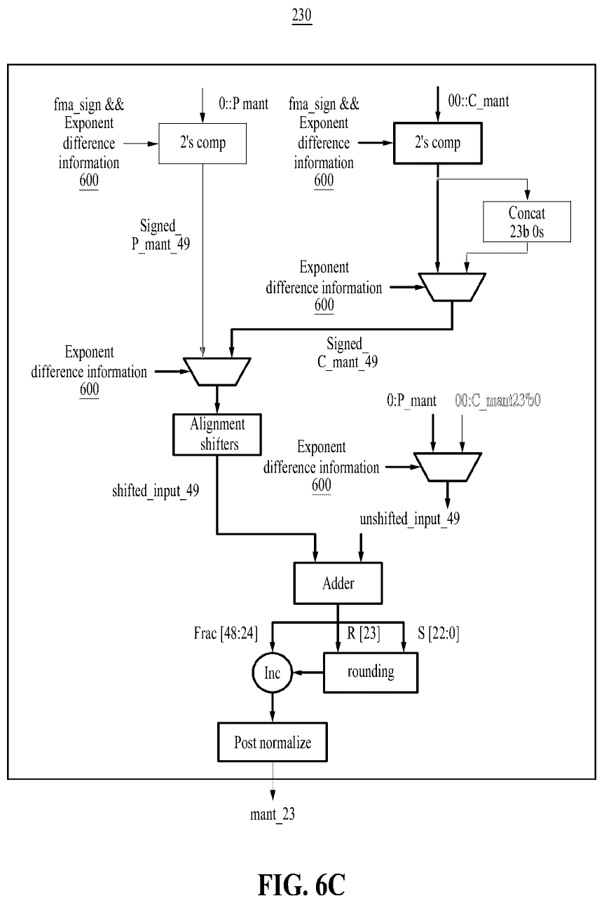

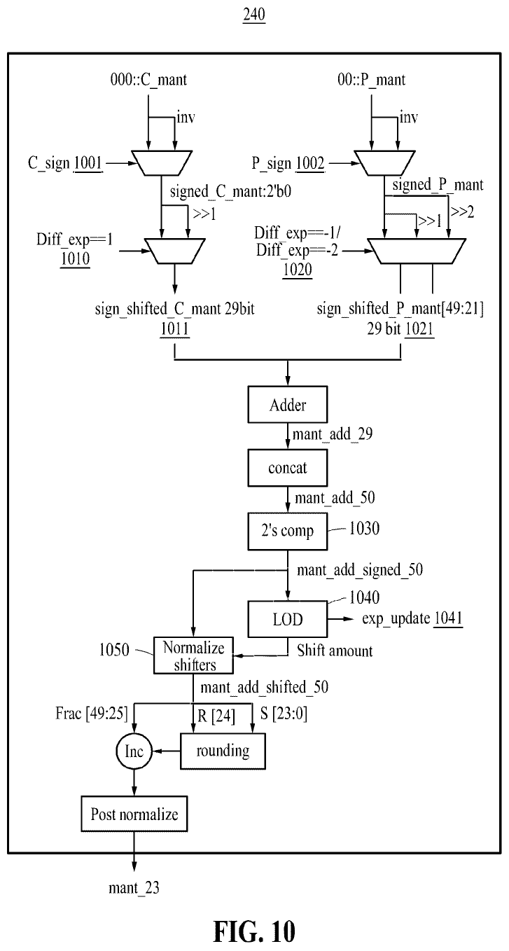

As described above, the FMA circuit 110 may provide the FMA operation result 120 by adding the third operand 103 to the multiplication result (e.g., A×B) of the first operand 101 and the second operand 102. When the third operand 103 is added to the multiplication result (e.g., A×B) of the first operand 101 and the second operand 102, the FMA circuit 110 may perform a bit-shift operation to change the exponent of the multiplication result and the exponent of the third operand 103 to be the same. In addition, when the multiplication result and the sign of the third operand 103 are different, the FMA circuit 110 may generate a complement (or a two's complement) corresponding to one of the multiplication result or the third operand 103. The bit-shift operation to be performed and the generating of the complement are described in detail below with reference to FIGS. 6A to 6C and FIG. 10, based on the FMA circuit 110.

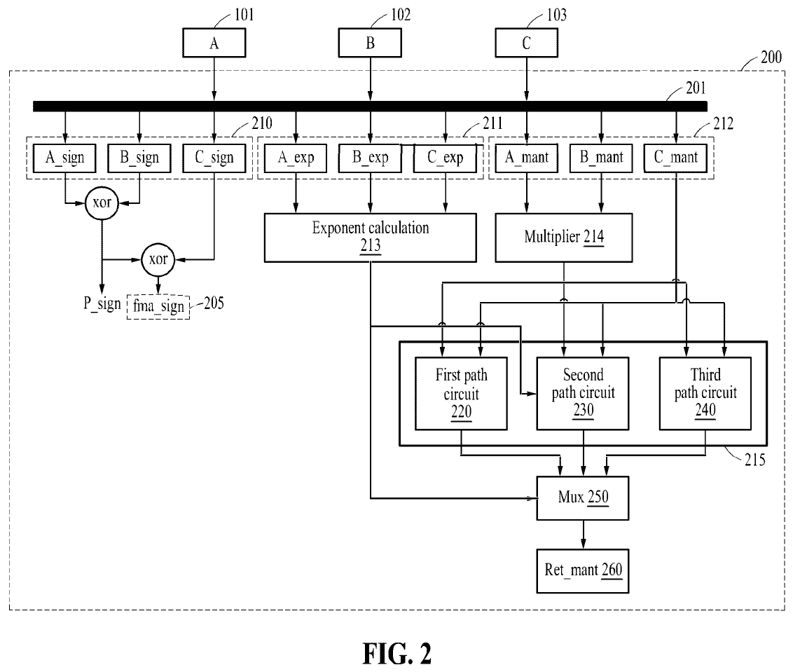

FIG. 2 is a block diagram illustrating an FMA circuit that varies FMA operation paths according to a plurality of path circuits.

An FMA circuit 200 according to an embodiment outputs an FMA operation result 260 (e.g., Ret_mant) based on the first operand 101, the second operand 102, and the third operand 103. For example, for the received first operand 101, the received second operand 102, and the received third operand 103, the FMA circuit 200 may output, as the FMA operation result 260, a result (e.g., A×B+C) obtained by ‘the first operand 101×the second operand 102+the third operand 103.’

The FMA circuit 200 includes a bit extractor 201 (e.g., a logic circuit), an exponent difference calculation circuit 213 (e.g., a subtractor), a multiplier 214, an operation module 215 (e.g., a processor), and a multiplexer (MUX) 250.

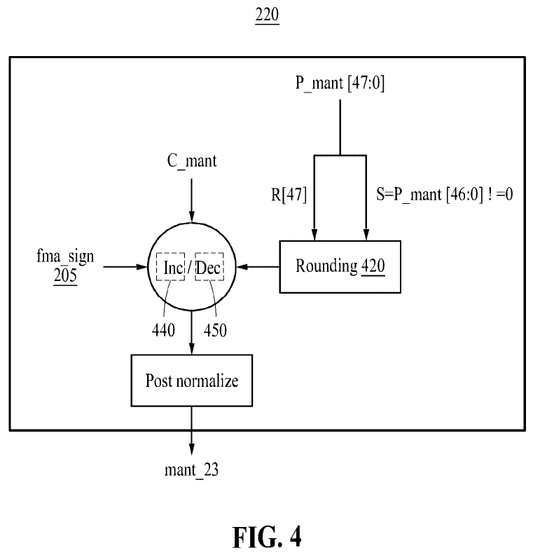

The bit extractor 201 may distinguish and extract a sign 210, an exponent 211, and a mantissa 212 respectively corresponding to the received first operand 101, the received second operand 102, and the received third operand 103, according to a bit position. For example, the bit extractor 201 may extract, as the sign 210, 1 bit corresponding to the most significant bit (MSB) of each of the first operand 101, the second operand 102, and the third operand 103 in the FP32 format. For example, the bit extractor 201 may extract, as the exponent 211, a total of 8 bits from a bit position that is closest to the MSB of each of the first operand 101, the second operand 102, and the third operand 103. For example, the bit extractor 201 may extract, as the mantissa 212, 23 bits corresponding to the remaining bit positions of each of the first operand 101, the second operand 102, and the third operand 103. The FMA circuit 200 may individually calculate each of the sign 210, the exponent 211, and the mantissa 212, which are extracted through the bit extractor 201, and may output the FMA operation result 260. For example, the FMA circuit 200 may calculate a sign P_sign corresponding to the multiplication of the first operand 101 and the second operand 102, based on a sign A_sign corresponding to the first operand 101 and a sign B_sign corresponding to the second operand 102 in the sign 210 extracted through the bit extractor 201. For example, the FMA circuit 200 may calculate the sign P_sign by performing an XOR operation on the sign A_sign and the sign B_sign. For example, when the first operand 101 is a negative number, the sign A_sign may be ‘l’, and when the second operand 102 is a positive number, the sign B_sign may be ‘0.’ Accordingly, in this case, the sign P_sign may be ‘1,’ which may indicate that the multiplication result between the first operand 101, which is a negative number, and the second operand 102, which is a positive number, is a negative number. The FMA circuit 200 may calculate a sign 205 (e.g., fma_sign) by performing an XOR operation on the sign P_sign and the sign C_sign corresponding to the third operand 103. That is, based on the sign 205, the FMA circuit 200 may determine whether to perform a two's complement generation operation when an FMA operation is performed. For example, when the result of A×B is a positive number and Cis a negative number, the FMA circuit 200 may perform the FMA operation by performing the two's complement generation operation on C to perform A×B+C. The determining of whether the FMA circuit 200 performs the two's complement generation operation based on the sign 205 is described in detail below with reference to FIG. 4 and FIGS. 6A to 6C.

The exponent difference calculation circuit 213 may determine an exponent difference between an exponent corresponding to the multiplication of the first operand 101 and the second operand 102 and an exponent corresponding to the third operand 103. For example, the exponent difference calculation circuit 213 may receive the exponent 211 of each of the first operand 101, the second operand 102, and the third operand 103 from the bit extractor 201. The exponent 211 may include an exponent A_exp corresponding to the first operand 101, an exponent B_exp corresponding to the second operand 102, and an exponent C_exp corresponding to the third operand 103. The exponent difference calculation circuit 213 may calculate the exponent corresponding to the multiplication of the first operand 101 and the second operand 102. For example, the exponent difference calculation circuit 213 may calculate a result obtained by adding the exponent A_exp corresponding to the first operand 101 to the exponent B_exp corresponding to the second operand 102 as the exponent (e.g., an exponent of A×B) corresponding to the multiplication of the first operand 101 and the second operand 102. The exponent difference calculation circuit 213 may determine the exponent for the multiplication of the first operand 101 and the second operand 102 (e.g., the exponent of A×B) by adding the exponent A_exp of the first operand 101 to the exponent B_exp of the second operand 102. The exponent difference calculation circuit 213 may determine the exponent difference by subtracting the exponent C_exp corresponding to the third operand 103 from the exponent (e.g., the exponent of A×B) corresponding to the multiplication of the operand 101 and the second operand 102.

The multiplier 214 may generate a multiplication result between mantissas corresponding to each of two operands. For example, the multiplier 214 may generate, from the bit extractor 201, a multiplication result between a mantissa A_mant and a mantissa B_mant by receiving the mantissa A_mant corresponding to the first operand 101 and the mantissa B_mant corresponding to the second operand 102. It may be necessary to individually calculate the sign 210, the exponent 211, and the mantissa 212 when an FMA operation is performed on the first operand 101, the second operand 102, and the third operand 103 in the FP32 format. For example, it may be assumed that an FMA operation corresponding to ‘A×B+C’ is performed when the first operand 101, the second operand 102, and the third operand 103 (e.g., A, B, and C) are each in the form of ‘(sign)×1. (mantissa bit)×2^{E}.’ For example, the sign corresponding to A×B may be affected only by the sign of A and the sign of B and may not be affected by the exponent or the mantissa of A or the exponent or the mantissa of B. In addition, the exponent corresponding to A×B may correspond to the sum between the exponent of A and the exponent of B and may not be affected by the sign or the mantissa of A or the sign or the mantissa of B. Furthermore, the mantissa corresponding to A×B may have a value corresponding to the multiplication of the mantissa of A and the mantissa of B. Accordingly, the multiplier 214 may generate a multiplication result corresponding to the mantissa of A×B by receiving the mantissa (e.g., A_mant) of the first operand 101 and the mantissa (e.g., B_mant) of the second operand 102.

According to an embodiment, the operation module 215 performs an operation corresponding to an addition operation among FMA operations on the first operand 101, the second operand 102, and the third operand 103. For example, the operation module 215 may generate a plurality of operation results from a mantissa multiplication result generated from the multiplier 214 and the mantissa corresponding to the third operand 103, based on a plurality of path circuits (e.g., a first path circuit 220, a second path circuit 230, and a third path circuit 240) respectively corresponding to a plurality of predetermined first to third exponent ranges. The predetermined first to third exponent ranges may be defined, for example, based on the exponent difference between the exponent corresponding to the multiplication of the first operand 101 and the second operand 102 and the exponent corresponding to the third operand 103. For example, the predetermined first to third exponent ranges that distinguish the exponent difference may be defined based on a bit-precision of at least one of the first operand 101, the second operand 102, and the third operand 103. The first path circuit 220, the second path circuit 230, and the third path circuit 240 may respectively correspond to the predetermined first to third exponent ranges. For example, the first path circuit 220 may represent a circuit for performing an FMA operation when the exponent difference belongs to the predetermined first exponent range. The first exponent range may be less than or equal to a first threshold value, and the first threshold value may be ‘−24’ based on the bit-precision of the first operand 101, the second operand 102, and the third operand 103 in the FP32 format. In another example, the second path circuit 230 may represent a circuit for performing an FMA operation when the exponent difference belongs to the predetermined second exponent range. The predetermined second exponent range may be greater than or equal to the first threshold value and less than a second threshold value, and greater than or equal to a third threshold value. Here, the second threshold value and the third threshold value may represent ‘−2’ and ‘2,’ respectively, when the decimal points between the mantissa corresponding to the multiplication of the first operand 101 and the second operand 102 and the mantissa corresponding to the third operand 103 are adjacent to each other. In another example, the third path circuit 240 may represent a circuit for performing an FMA operation when the exponent difference belongs to the predetermined third exponent range. The predetermined third exponent range may be greater than or equal to the second threshold value (e.g., ‘−2’) and less than the third threshold value (e.g., ‘2’). That is, for the generated mantissa multiplication result (e.g., A_mant×B_mant) and the mantissa (e.g., C_mant) corresponding to the third operand 103, the operation module 215 may perform, among the FMA operations (e.g., A×B+C), an operation corresponding to the mantissa (e.g., +C) of the third operand 103 on the result of A×B, based on the first path circuit 220, the second path circuit 230, and the third path circuit 240 so that the exponent difference between the exponent corresponding to the multiplication result of the first operand 101 and the second operand 102 and the exponent corresponding to the third operand 103 is distinguished by the exponent range to which the exponent difference belongs.

The operation module 215 according to an embodiment may include the first path circuit 220, the second path circuit 230, and the third path circuit 240 respectively corresponding to the predetermined first to third exponent ranges. The first path circuit 220, the second path circuit 230, and the third path circuit 240 may be distinguished into FMA operation paths that vary according to the predetermined exponent range to which the exponent difference belongs. For reference, the exponent of A×B and the exponent of C may need to be matched to be the same to perform an FMA operation corresponding to A×B+C. In this case, a smaller exponent value may be matched with a larger exponent value. However, when the exponent difference between the exponent of A×B and the exponent of C is greater than a certain threshold value, the proportion of a mantissa of an operand having a less exponent value may be reduced in the FMA operation (that is, even when a mantissa of an operand having a less exponent value is added to an operand having a large exponent value, a value of the operand having a large exponent value may not be significantly changed). In another example, when the exponent difference between the exponent of A×B and the exponent of C is less than a certain threshold value, the mantissa of each operand occupies a large proportion in the FMA operation, so the variation may be large when performing an addition. Accordingly, by distinguishing the operation paths according to the exponent difference to implement the FMA operation, it may be possible to simplify the FMA circuit 200 by reducing the complexity of the arrangement or the number of logical operation elements for the FMA operation.

Each of the first path circuit 220, the second path circuit 230, and the third path circuit 240 may represent a set including at least one logical operation element. For example, the first path circuit 220, the second path circuit 230, and the third path circuit 240 may represent a set in which logical operation elements (e.g., a multiplier, an adder, a shifter, etc.) for performing an FMA operation are connected to each other along a data propagation path. For example, one of the first path circuit 220, the second path circuit 230, and the third path circuit 240 may include an adder and a shifter. For example, the first path circuit 220, the second path circuit 230, and the third path circuit 240 may include adders and shifters of different sizes to implement operation paths distinguished according to the exponent difference or may include another operation circuit (e.g., an incrementer/decrementer circuit) to replace the adders. The incrementer/decrementer circuit may be implemented by a counter. An embodiment of the first path circuit 220, the second path circuit 230, and the third path circuit 240 is described below with reference to FIG. 4, FIGS. 6A to 6C, and FIG. 10. The first path circuit 220, the second path circuit 230, and the third path circuit 240 may generate an operation result (e.g., an operation result corresponding to A×B+C) by receiving, from the multiplier, the mantissa C_mant corresponding to the third operand 103 from the bit extractor 201 and receiving the mantissa (e.g., the mantissa corresponding to A×B) corresponding to the multiplication of the first operand 101 and the second operand 102. The first path circuit 220, the second path circuit 230, and the third path circuit 240 may represent circuits that implement sum data paths, distinguished based on the determined exponent difference for the received mantissas (e.g., the mantissa corresponding to A×B and the mantissa C_mant). For example, the first path circuit 220 may represent a circuit to implement an FMA operation when the determined exponent difference belongs to the predetermined first exponent range. Specifically, when the determined exponent difference is less than the first threshold value, the first path circuit 220 may represent a circuit to implement an operation path that sums the mantissa (e.g., the mantissa corresponding to A×B) corresponding to the multiplication of the first operand 101 and the second operand 102 and the mantissa C_mant corresponding to the third operand 103. For example, the second path circuit 230 may represent a circuit to implement an FMA operation when the determined exponent difference belongs to the predetermined second exponent range. Specifically, the second path circuit 230 may represent a circuit to implement an operation path that sums the mantissa corresponding to A×B and the mantissa C_mant when the determined exponent difference is greater than or equal to the first threshold value and less than the second threshold value, or greater than or equal to the third threshold value. For example, the third path circuit 240 may represent a circuit to implement an FMA operation when the determined exponent difference belongs to the predetermined third exponent range. Specifically, the third path circuit 240 may represent a circuit to implement an operation path that sums the mantissa corresponding to A×B and the mantissa C_mant when the determined exponent difference is greater than or equal to the second threshold value and less than the third threshold value. Accordingly, a first operation result generated from the first path circuit 220 may be selected as the FMA operation result 260 when the exponent difference belongs to the predetermined first exponent range (e.g., less than the first threshold value), a second operation result generated from the second path circuit 230 may be selected as the FMA operation result 260 when the exponent difference belongs to the predetermined second exponent range (e.g., greater than or equal to the first threshold value and less than the second threshold value, or greater than or equal to the third threshold value), and a third operation result generated from the third path circuit 240 may be selected as the FMA operation result 260 when the exponent difference belongs to the predetermined third exponent range (e.g., greater than or equal to the second threshold value and less than the third threshold value).

The FMA circuit 200 may implement three different FMA operation paths based on the first path circuit 220, the second path circuit 230, and the third path circuit 240. The FMA circuit 200 may perform a rounding operation and a normalization task differently for each path by implementing the three different FMA operation paths through the first path circuit 220, the second path circuit 230, and the third path circuit 240. The rounding operation may include rounding or rounding down at a certain bit position (e.g., a round bit) of the mantissa corresponding to A×B+C. The normalization task may represent a task for changing the mantissa corresponding to A×B+C to a decimal number having a 1-digit integer part. The operation path implemented through the first path circuit 220 may be referred to as a farther path, the operation path implemented through the second path circuit 230 may be referred to as a far path (or a long path), and the operation path implemented through the third path circuit 240 may be referred to as a close path (or a short path) but are not limited thereto.

In response to the determined exponent difference value, the MUX 250 may select and output, as the FMA operation result 260, one of the operation results received from the first path circuit 220, the second path circuit 230, and the third path circuit 240. For example, the MUX 250 may select, as the FMA operation result 260, one of the operation results received from the first path circuit 220, the second path circuit 230, and the third path circuit 240 by receiving the determined exponent difference from the exponent difference calculation circuit 213. For example, the MUX 250 may select and output, as the FMA operation result 260, the first operation result generated from the first path circuit 220 among the plurality of operation results in response to the determined exponent difference belonging to the predetermined first exponent range (e.g., less than the first threshold value). For example, the MUX 250 may select, as the FMA operation result 260, the second operation result generated from the second path circuit 230 in response to the determined exponent difference belonging to the predetermined second exponent range (e.g., greater than or equal to the first threshold value and less than the second threshold value, or greater than or equal to the third threshold value). For example, the MUX 250 may select, as the FMA operation result 260, the third operation result generated from the third path circuit 240 in response to the determined exponent difference belonging to the predetermined third exponent range (e.g., greater than or equal to the second threshold value and less than the third threshold value). In an embodiment, the second threshold value is greater than the first threshold value, the third threshold value is greater than the second threshold value, and a fourth threshold value is greater than the third threshold value. In addition, when comparing the sizes of threshold values, the sign is considered, meaning a threshold value that is negative is defined as being less than a positive threshold value, and a larger negative value is defined as a smaller value. The first threshold value and the fourth threshold value may be defined based on the bit-precision corresponding to at least one of the first operand 101, the second operand 102, and the third operand 103. For example, when the first operand 101, the second operand 102, and the third operand 103 are FP32, the bit-precision of FP32 may correspond to a value obtained by adding ‘1’ to ‘23,’ which is a mantissa number. The first threshold value may correspond to ‘−24,’ and the fourth threshold value may correspond to ‘24.’ The second threshold value and the third threshold value may be determined based on a positional relationship of the decimal points of two floating points (e.g., mantissas) to be added. For example, when the multiplication result of the first operand 101 and the second operand 102 is 1.3456×23 and the third operand 103 is 1.01×23, this may indicate that each exponent may be the same as ‘3,’ and thus the decimal points may be the same. That is, when the exponents of two floating points have similar values, an overlapping portion of the mantissas of the floating points to be added may increase, so a separate operation path may be required. For example, the second threshold value may correspond to ‘−2,’ and the third threshold value may correspond to ‘2.’

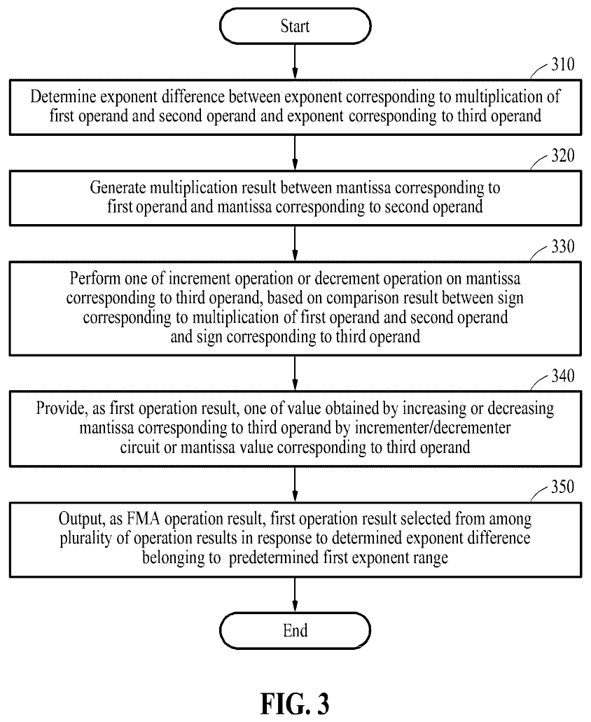

FIG. 3 is a flowchart illustrating an FMA operation method based on a first path circuit of an FMA circuit, according to an embodiment.

In operation 310, an FMA circuit according to an embodiment determines an exponent difference between an exponent corresponding to the multiplication of a first operand and a second operand and an exponent corresponding to a third operand. For example, the FMA circuit may determine the exponent corresponding to the multiplication of the first operand and the second operand to be ‘10’ when the multiplication result of the first operand and the second operand is 1.01×210. The FMA circuit may determine a value obtained by subtracting the exponent corresponding to the third operand from ‘10’ to be the exponent difference. The FMA circuit may select and output, as an FMA operation result, an operation result generated from a certain path circuit, based on an exponent range to which the determined exponent difference belongs.

In operation 320, the FMA circuit according to an embodiment generates a mantissa multiplication result between a mantissa corresponding to the first operand and a mantissa corresponding to the second operand. For example, the FMA circuit may multiply the mantissa corresponding to the first operand by the mantissa corresponding to the second operand to generate the mantissa multiplication result. As described above, a sign, an exponent, and a mantissa of each of floating points may be individually calculated when a multiplication operation is performed between different floating points. For example, when the multiplication operation is performed between different floating points, the sign multiplication result may be calculated through a logical operation (e.g., an XOR operation) between the signs of each of the first operand and the second operand. For example, the exponent multiplication result between different floating points may be calculated through the sum (or the difference) between exponents. Accordingly, the mantissa multiplication result between the first operand and the second operand may be generated through the product between mantissas corresponding to each of the first operand and the second operand, excluding the exponent or the sign corresponding to each of the first operand and the second operand. For example, the mantissa multiplication result of the first and second operands may be generated by multiplying the mantissas of each operand, excluding their corresponding exponents and signs,

In operation 330, according to an embodiment, a first path circuit of the FMA circuit performs one of an increment operation or a decrement operation on a mantissa corresponding to the third operand, based on a comparison result between a sign corresponding to the multiplication of the first operand and the second operand and a sign corresponding to the third operand. For example, the first path circuit (e.g., the first path circuit 220 of FIG. 2) included in the FMA circuit may perform one of the increment operation or the decrement operation on the mantissa (e.g., C_mant of FIG. 2) corresponding to the third operand, based on the comparison result (e.g., an XOR operation result) between the sign operation result between the sign (e.g., A_sign of FIG. 2) of the first operand and the sign (e.g., B_sign of FIG. 2) of the second operand and the sign (e.g., C_sign) corresponding to the third operand. To perform the FMA operation, the first path circuit may consider the sign operation result between the sign (e.g., A_sign of FIG. 2) of the first operand and the sign (e.g., B_sign of FIG. 2) of the second operand and the sign (e.g., C_sign of FIG. 2) corresponding to the third operand. For example, it may be assumed that the FMA circuit performs an operation of adding ‘+1.5’ to ‘+1.’ Since ‘+1.5’ and ‘+1’ are both positive numbers, the sum result may be ‘+2.5.’ That is, the result obtained by summing a positive number to a positive number has an increased value compared to the numbers to be added, so the result may correspond to the FMA circuit performing the increment operation. In another example, it may be assumed that the FMA circuit performs an operation of adding ‘−1.5’ to ‘−1.’ Since ‘−1.5’ and ‘−1’ are both negative numbers, the sum result may be ‘−2.5.’ As described above with reference to FIG. 2, herein, a larger negative value may correspond to a smaller number, so the result obtained by summing a negative number and a negative number may have a decreased value compared to the numbers to be added. Accordingly, the FMA circuit may perform the decrement operation to calculate the addition result between negative numbers. Accordingly, the FMA circuit may perform one of the increment operation or the decrement operation by considering signs of operands to be summed. The FMA circuit may perform one of the increment operation or the decrement operation on the mantissa corresponding to the third operand, based on an incrementer/decrementer circuit (or a counter) included in the first path circuit. For example, the incrementer/decrementer circuit may perform one of an operation of increasing the mantissa by a 1-bit value or an operation of decreasing the mantissa by a 1-bit value. The first path circuit may decrease the overall size and complexity of the FMA circuit by replacing an adder with the incrementer/decrementer circuit.

In operation 340, according to an embodiment, the first path circuit of the FMA circuit may provide, as a first operation result, one of a value obtained by increasing or decreasing the mantissa corresponding to the third operand by the incrementer/decrementer circuit or a mantissa value corresponding to the third operand. For example, when the determined exponent difference is a predetermined exponent difference (e.g., ‘−25’) in a first exponent range, the first path circuit may provide, to the incrementer/decrementer circuit, a rounding result of an intermediate operation between the mantissa multiplication result and the mantissa corresponding to the third operand. For example, the first path circuit may provide a rounding bit to the incrementer/decrementer circuit from an intermediate operation result (e.g., a value corresponding to A×B+C before rounding) obtained by adding the mantissa corresponding to the multiplication of the first operand and the second operand to the mantissa corresponding to the third operand. For reference, a rounding operation (e.g., round to nearest even) may include an operation of searching for the closest number that represents the intermediate operation result as the FP32 format because a bit for expressing the mantissa of FP32 is limited (e.g., 23 bits). For example, the rounding operation may indicate skipping rounding for a certain bit when the rounding bit value is ‘0’ or performing rounding on a certain bit when the rounding bit value is ‘1.’ Here, the rounding operation may indicate rounding down when the rounding bit value is ‘0’ and may indicate rounding up when the rounding bit value is ‘1’ but it is not limited thereto and may also be referred to vice versa. The first path circuit may apply the rounding operation to the intermediate operation result when the exponent difference between the exponent corresponding to the multiplication of the first operand and the second operand and the exponent corresponding to the third operand is ‘−25,’ and may skip the rounding operation when the exponent difference is less than ‘−25.’ When the exponent difference is less than ‘−25’ (e.g., ‘−26,’−27′, etc.), even when the rounding operation is performed, the effect on the mantissa corresponding to the third operand is insignificant, so the amount of unnecessary operations may be reduced by skipping the rounding operation. For reference, in the FP32 operation, when the exponent difference is ‘−25,’ the MSB of the mantissa corresponding to A×B may correspond to the rounding bit, and in the BP16 operation, a 15-th bit place of the mantissa corresponding to C may correspond to the rounding bit place. For example, when the determined exponent difference is the predetermined exponent difference (e.g., ‘−25’) and the rounding result is rounding up (for example, the rounding bit is ‘1’), the first path circuit may generate the first operation result by increasing or decreasing the mantissa corresponding to the third operand. In another example, when the determined exponent difference is not the predetermined exponent difference or the rounding result is rounding down (for example, the rounding bit is ‘0’), the first path circuit may provide the mantissa corresponding to the third operand as the first operation result. That is, when the determined exponent difference is the predetermined exponent difference (e.g., ‘−25’) in the first exponent range, the first path circuit may consider whether to perform rounding on the intermediate operation result (e.g., a value corresponding to A×B+C before rounding), and in other cases, whether to perform rounding may be skipped. In addition, even considering whether to perform rounding on the intermediate operation result, the first path circuit may generate the first operation result by increasing or decreasing the mantissa corresponding to the third operand when the rounding result is rounding up, and in other cases (for example, the rounding result is rounding down when the exponent difference is not the predetermined exponent difference or even when the exponent difference is the predetermined exponent difference), the first path circuit may provide the mantissa corresponding to the third operand as the first operation result.

In operation 350, the FMA circuit according to an embodiment, outputs, as the FMA operation result, the first operation result selected from among a plurality of operation results in response to the determined exponent difference belonging to the predetermined first exponent range (e.g., less than a first threshold value).

FIG. 4 is a block diagram illustrating a structure of a first path circuit, according to an embodiment.

As described above with reference to FIG. 2, the first path circuit 220 according to an embodiment may correspond to a circuit for implementing a path (e.g., a farther path) that performs an FMA operation when an exponent difference between an exponent corresponding to the multiplication of a first operand and a second operand and an exponent corresponding to a third operand belongs to a first exponent range (e.g., less than a first threshold value). When the exponent difference is less than the first threshold value, the MSB of a mantissa corresponding to the multiplication of the first operand and the second operand may be placed at least one space to the right (e.g., 1 bit to the right) compared to the least significant bit (LSB) of a mantissa corresponding to the third operand. That is, even when the mantissa corresponding to the multiplication of the first operand and the second operand is added to the mantissa corresponding to the third operand, there may be no significant change in the mantissa corresponding to the third operand. However, when all mantissas corresponding to the multiplication of the first operand and the second operand are excluded from a mantissa sum operation, the operation precision may decrease. Accordingly, the first path circuit 220 may increase the FMA operation precision through a rounding circuit 420 (e.g., a logic circuit) to determine whether to perform rounding. For example, when the exponent difference is ‘−25,’ the first path circuit 220 may include the rounding circuit 420 that provides, to incrementer/decrementer circuits 440 and 450, a rounding result of an intermediate operation between the mantissa multiplication result and the mantissa corresponding to the third operand. For reference, in FIG. 4, the incrementer/decrementer circuits 440 and 450 are expressed as one integrated block, but each may be expressed as a separate block. Further, the decrementer circuit 450 may be implemented in software based on the incrementer circuit 440 or vice versa. The first path circuit 220 may determine P_mant[47], which is the MSB bit place value, to be a round bit (hereinafter, referred to as ‘R [47]’) in the mantissa (hereinafter, referred to as ‘P_mant[47:0]’) corresponding to the multiplication of the first operand and the second operand. The first path circuit 220 may determine the remaining bits (e.g., P_mant[46:0]), excluding the MSB from P_mant[47:0] to be sticky bits (herein, although the description is based on a case in which operands are FP32, when the operands are BF16, a 15-th bit of the third operand may be determined to be a round bit, and the entire mantissa corresponding to the remaining bits and the multiplication of the first operand and the second operand may be determined to be sticky bits). For example, the rounding circuit 420 may determine, to be rounding up, a case in which the determined exponent difference is ‘−25’ and the remaining bits (e.g., P_mant[46:0]) are not ‘0’ and may provide a round bit value corresponding to ‘1’ to the incrementer/decrementer circuits 440 and 450. In another example, the rounding circuit 420 may determine, to be rounding down, a case in which the remaining bits (e.g., P_mant[46:0]) are ‘0,’ even when the determined exponent difference is ‘−25,’ and may provide a round bit value corresponding to ‘0’ to the incrementer/decrementer circuits 440 and 450.

The first path circuit 220 may be implemented as a digital circuit. For example, the first path circuit 220 may include a binary-incrementer circuit that increases the mantissa (e.g., C_mant) corresponding to the third operand by a 1-bit value and a binary-decrementer circuit that decreases the mantissa (e.g., C_mant) corresponding to the third operand by a 1-bit value. For reference, the size of the first path circuit 220 may be reduced by replacing an adder having a large size with the incrementer/decrementer circuits 440 and 450. For example, the first path circuit 220 may include a digital circuit including the incrementer circuit 440 of 24 bits and/or the decrementer circuit 450 of 24 bits. The incrementer circuit/decrementer circuits 440 and 450 may generate a first operation result by increasing or decreasing the mantissa (e.g., C_mant) corresponding to the third operand, based on the comparison result (e.g., the sign 205 of FIG. 2) between the sign (e.g., P_sign of FIG. 2) corresponding to the multiplication of the first operand and the second operand and the sign corresponding to the third operand. For example, when it is determined that rounding up is to be performed on the rounding circuit 420, in response to the sign 205 being ‘0’ (that is, the signs of A×B and C are the same), the incrementer circuit 440 may increase the mantissa C_mant corresponding to the third operand by ‘l’ and may generate a first operation result mant_23 obtained by normalizing the A×B+C result through post normalization. In another example, when it is determined that rounding up is to be performed on the rounding circuit 420, in response to the sign 205 being ‘0,’ the decrementer circuit 450 may decrease the mantissa C_mant corresponding to the third operand by ‘l’ and may generate the first operation result mant_23 obtained by normalizing the A×B+C result through post normalization. The first path circuit 220 may skip a rounding operation for the mantissa C_mant and may determine the mantissa C_mant to be the mantissa (e.g., mant_23) corresponding to the first operation result in other cases rather than a case in which the mantissa C_mant increases or decreases based on the incrementer circuit/the decrementer circuits 440 and 450 described above (e.g., in the case of rounding down or when the determined exponent difference belongs to the first exponent range but not ‘−25’).

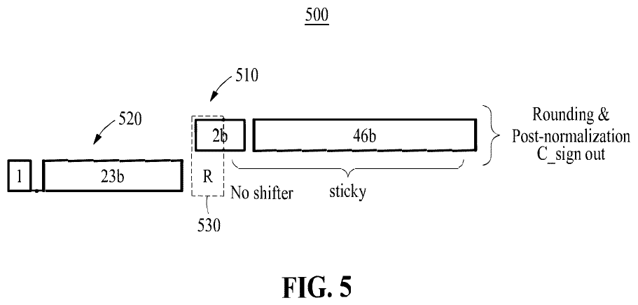

FIG. 5 illustrates an example in which an FMA circuit selects, as an FMA operation result, a first operation result generated based on a first path circuit, according to an embodiment.

In an example 500, the description is based on a case in which first to third operands are FP32. The example 500 shows a positional relationship between a mantissa 510 (hereinafter, referred to as a ‘multiplication mantissa’) corresponding to the multiplication of the first operand and the second operand and a mantissa 520 corresponding to the third operand. An FMA circuit according to an embodiment selects, as an FMA operation result, a first operation result generated based on a first path circuit when an exponent difference between an exponent corresponding to the multiplication of the first operand and the second operand and an exponent corresponding to the third operand is less than a first threshold value. The first threshold value may correspond to ‘−24,’ and the example 500 shows the positional relationship between the multiplication mantissa 510 and the mantissa 520 corresponding to the third operand when the exponent difference is ‘−25.’ Since the exponent difference is ‘−25,’ the MSB of the multiplication mantissa 510 may be placed 25 spaces to the right (e.g., 25 bits to the right) compared to the mantissa 520. Since the mantissa 520 includes 24 bits, it may be difficult for a value of the multiplication mantissa 510 to affect the mantissa 520, even when the multiplication mantissa 510 is added to the mantissa 520. However, in the example 500, the FMA circuit may determine the MSB of the multiplication mantissa 510 to be a round bit R by considering the bit precision after the multiplication mantissa 510 is added to the mantissa 520. The FMA circuit may determine the remaining bits, excluding the MSB of the multiplication mantissa 510, to be sticky bits. For example, when the FMA circuit applies a rounding operation (e.g., round to nearest even) to the addition result of the multiplication mantissa 510 and the mantissa 520, rounding up may be performed when a value, which is 1 bit before the round bit R, is ‘1.’ When rounding up is performed, the FMA circuit may increase or decrease the mantissa 520 by ‘1,’ based on a sign (hereinafter, referred to as a ‘multiplication sign’) corresponding to the multiplication of the first operand and the second operand and a sign corresponding to the third operand. For example, the FMA circuit may perform rounding up, and at the same time, may increase the mantissa 520 by ‘1’ when the multiplication sign is the same as the sign of the third operand. In another example, the FMA circuit may perform rounding up, and at the same time, may decrease the mantissa 520 by ‘1’ when the multiplication sign is different from the sign of the third operand. Through this, the FMA circuit may implement a result of increasing ‘1.5’ to ‘2’ by rounding ‘1.5’ at the first decimal point and decreasing ‘−1.5’ to ‘−2’ by rounding ‘−1.5’ at the first decimal point.

FIGS. 6A to 6C are block diagrams illustrating a structure of a second path circuit, according to an embodiment.

As described above with reference to FIG. 2, in FIGS. 6A to 6C, a second path circuit 230 according to an embodiment corresponds to a circuit for implementing an FMA operation path (e.g., a far path or a long path) when an exponent difference between an exponent corresponding to the multiplication of a first operand and a second operand and an exponent corresponding to a third operand is one of an exponent difference that is greater than or equal to a first threshold value and less than a second threshold value, and an exponent difference that is greater than or equal to a third threshold value. The second path circuit 230 may generate a second operation result (e.g., mant_23) based on a mantissa (e.g., 0::P_mant) corresponding to the multiplication of the first operand and the second operand and a mantissa (e.g., 00::C_mant) corresponding to the third operand. The second operation result (e.g., mant_23) may include a mantissa corresponding to ‘the first operand×the second operand+the third operand’. The second path circuit 230 may include a 49-bit adder and a 23-bit alignment shifter. The second path circuit 230 may perform, through the 23-bit alignment shifter, a bit shift on a mantissa of an operand corresponding to an exponent having a smaller value among the exponent corresponding to the multiplication of the first operand and the second operand and the exponent corresponding to the third operand, based on the exponent difference. That is, when (the exponent corresponding to the multiplication of the first operand and the second operand—the exponent corresponding to the third operand) is a positive number, the mantissa (e.g., 0::P_mant) corresponding to the multiplication of the first operand and the second operand may be bit-shifted by the exponent difference, and when (the exponent corresponding to the multiplication of the first operand and the second operand—the exponent corresponding to the third operand) is a negative number, the mantissa (e.g., 00::C_mant) corresponding to the third operand may be bit-shifted by the exponent difference. That is, if the difference between the exponent of the product of the first and second operands and the exponent of the third operand is positive, the mantissa (e.g., 0::P_mant) of the product may be bit-shifted by the exponent difference. Conversely, if the difference is negative, the mantissa (e.g., 00::C_mant) of the third operand may be bit-shifted by the exponent difference. For example, the bit-shifting may include an operation of moving a mantissa to one of the right or the left by ‘3’ when the exponent difference is ‘3.’ The second path circuit 230 may generate, as the second operation result, a result obtained by adding the mantissa of the shifted operand to other mantissas, through the 49-bit adder.

In the second path circuit 230, the FMA operation method may be divided into three detailed paths, based on the sign (the sign 205 of FIG. 2) and the exponent difference. The second path circuit 230 may activate FMA operation data paths individually based on exponent difference information 600 corresponding to the exponent difference received from an exponent difference calculation circuit (e.g., the exponent difference calculation circuit 213 of FIG. 2). For example, in the second path circuit 230, a case in which the exponent difference is greater than or equal to the first threshold value and less than the second threshold value, a case in which the exponent difference is greater than or equal to the third threshold value and less than a fourth threshold value, and a case in which the exponent difference is greater than or equal to the fourth threshold value may be divided into first to third detailed paths, respectively.

Hereinafter, an FMA operation method is described for each of the three detailed paths.

FIG. 6A describes the generation of an FMA operation result (e.g., mant_23) based on the mantissa (e.g., 0::P_mant) corresponding to the multiplication of the first operand and the second operand and the mantissa (e.g., 00::C_mant) corresponding to the third operand along the first detailed path in the second path circuit 230. The first detailed path may represent a data path for an FMA operation when the exponent difference between the exponent corresponding to the multiplication of the first operand and the second operand and the exponent corresponding to the third operand is greater than or equal to the first threshold value (e.g., ‘−24’) and less than the second threshold value (e.g., ‘−2’).

In the first detailed path, the second path circuit 230 may generate a two's complement for the mantissa (e.g., 0::P_mant) corresponding to the multiplication of the first operand and the second operand, based on a two's complement generation signal (e.g., the exponent difference information 600). For example, the two's complement generation signal (e.g., the exponent difference information 600) may be determined based on a sign (e.g., the sign 205 of FIG. 2, and hereinafter, referred to as ‘fma_sign’) corresponding to the multiplication of the first operand and the second operand and the exponent difference information 600. For example, the two's complement generation signal (e.g., the exponent difference information 600) may represent a signal that is activated when both a condition in which a value of fma_sign is ‘1’ (that is, the multiplication result of the first operand and the second operand and the sign of the third operand are different) and a condition in which the exponent difference between the exponent corresponding to the multiplication of the first operand and the second operand and the exponent corresponding to the third operand is greater than or equal to the first threshold value (for example, ‘−24’ when operands are FP32) and less than the second threshold value (for example, ‘−2’ when operands are FP32) are satisfied. That is, the second path circuit 230 may generate the two's complement for the mantissa (e.g., 0::P_mant) corresponding to the third operand when both the fma_sign condition and the exponent difference condition described above are satisfied. Based on the two's complement generation signal (e.g., the fma_sign && exponent difference information 600), the two's complement for the mantissa (e.g., 0::P_mant) corresponding to the multiplication of the generated first operand and the generated second operand may be referred to as signed_P_mant_49.

In the first detailed path, the second path circuit 230 may determine, to be a mantissa to be shifted, the mantissa (e.g., 0::P_mant) corresponding to the multiplication of the first operand and the second operand, based on the exponent difference information 600. That is, in the first detailed path, the second path circuit 230 may generate a mantissa (e.g., shifted_input_49) obtained by bit-shifting the mantissa (e.g., 0::P_mant) by ‘the number of sign inversions of the exponent difference’ by inputting the mantissa (e.g., 0::P_mant) corresponding to the multiplication of the first operand and the second operand to a shifter (e.g., an alignment shifter), based on the exponent difference information 600 corresponding to the fact that the exponent difference between the exponent corresponding to the multiplication of the first operand and the second operand and the exponent corresponding to the third operand is greater than the first threshold value (e.g., ‘−24’) and less than the second threshold value (e.g., ‘−2’). For reference, when the exponent difference between the exponent corresponding to the multiplication of the first operand and the second operand and the exponent corresponding to the third operand is greater than or equal to the first threshold value (e.g., ‘−24’) and less than the second threshold value (e.g., ‘−2’), the exponent difference is a negative number, so the mantissa (e.g., 0::P_mant) may be bit-shifted by the number of sign inversions of the exponent difference.

In the first detailed path, the second path circuit 230 may select an unshifted mantissa based on the exponent difference information 600. In the first detailed path, since the exponent difference is a negative number, the exponent corresponding to the multiplication of the first operand and the second operand may be less than the exponent corresponding to the third operand. Accordingly, the mantissa (e.g., 00::C_mant::23′b0) obtained by coupling ‘0’ of 23 bits with the LSB of the mantissa (e.g., 00::C_mant) corresponding to the third operand having a large exponent may be determined to be the unshifted mantissa (e.g., unshifted_input_49).

In the first detailed path, the second path circuit 230 may generate the second operation result (e.g., mant_23) by inputting the shifted mantissa (e.g., shifted_input_49) and the unshifted mantissa (e.g., unshifted_input_49) to an adder.

In the first detailed path, the second path circuit 230 may input the shifted mantissa (e.g., shifted_input_49) and the unshifted mantissa (e.g., unshifted_input_49) to the adder and may output Frac [48:24], R:[23], and S[22:0]. The second path circuit 230 may perform a rounding operation (e.g., rounding) on Frac [48:24] based on R:[23] and S [22:0]. In addition, the second path circuit 230 may generate the second operation result (e.g., mant_23) by normalizing (e.g., post-normalizing) the result that is output from the adder.

The first detailed path is an FMA operation path in which the exponent corresponding to the third operand is greater than the exponent corresponding to the multiplication of the first operand and the second operand, so the exponent and the sign corresponding to the second operation result may be the same as the exponent and the sign corresponding to the third operand. Although not shown in FIG. 6A, a MUX (e.g., the MUX 250 of FIG. 2) may output, as the FMA operation result, the second operation result generated from the second path circuit 230 along the first detailed path in response to the determined exponent difference being greater than or equal to the first threshold value (e.g., ‘−24’) and less than the second threshold value (e.g., ‘−2’).

FIG. 6B describes the generation of the FMA operation result (e.g., mant_23) based on the mantissa (e.g., 0::P_mant) corresponding to the multiplication of the first operand and the second operand and the mantissa (e.g., 00::C_mant) corresponding to the third operand along the second detailed path in the second path circuit 230. The second detailed path may represent a data path for an FMA operation when the exponent difference between the exponent corresponding to the multiplication of the first operand and the second operand and the exponent corresponding to the third operand is greater than or equal to a third threshold value (e.g., ‘2’) and less than a fourth threshold value (e.g., ‘24’).

In the second detailed path, the second path circuit 230 may generate a two's complement for the mantissa (e.g., 00::C_mant) corresponding to the third operand, based on the two's complement generation signal (e.g., the exponent difference information 600). A detailed method of generating the two's complement is the same as the description in the first detailed path provided above, so a repeated description thereof is omitted. However, unlike in the first detailed path, in the second detailed path, the exponent difference information 600 may correspond to the exponent difference that is greater than or equal to the third threshold value (e.g., ‘2’) and less than the fourth threshold value (e.g., ‘24’).

In the second detailed path, the second path circuit 230 may perform zero-padding (e.g., ‘concat 23b 0s’ of FIG. 6B) on the mantissa (e.g., 00::C_mant) corresponding to the third operand. For example, the second path circuit 230 may perform zero-padding on the LSB of the mantissa (e.g., 00::C_mant) corresponding to the third operand with ‘0’ of 23 bits. For example, the zero-padding may add one or more zeros to the right side or least significant side of the mantissa.

In the second detailed path, the second path circuit 230 may determine, to be a mantissa to be shifted, the zero-padded mantissa (e.g., the mantissa obtained by performing zero-padding on the LSB of 00::C_mant with 23b 0), based on the exponent difference information 600. That is, in the second detailed path, the second path circuit 230 may generate the mantissa (e.g., shifted_input_49) obtained by bit-shifting the zero-padded mantissa by the exponent difference by inputting the zero-padded mantissa to the shifter (e.g., the alignment shifter), based on the exponent difference information 600 corresponding to a case in which the exponent difference between the exponent corresponding to the multiplication of the first operand and the second operand and the exponent corresponding to the third operand is greater than or equal to the third threshold value and less than the fourth threshold value.

In the second detailed path, the second path circuit 230 may select an unshifted mantissa based on the exponent difference information 600. In the second detailed path, like in the first detailed path, the exponent difference is a positive number, so the exponent corresponding to the multiplication of the first operand and the second operand may be greater than the exponent corresponding to the third operand. Accordingly, in the second detailed path, the second path circuit 230 may perform a bit shift on a mantissa corresponding to an operand having a less exponent, so the mantissa (e.g., 0::P_mant) corresponding to an operand having a large exponent may be determined to be the unshifted mantissa (e.g., unshifted_input_49).

In the second detailed path, the second path circuit 230 may generate the second operation result (e.g., mant_23) by inputting the shifted mantissa (e.g., shifted_input_49) and the unshifted mantissa (e.g., unshifted_input_49) to the adder. The generating of the second operation result in the second detailed path, and the exponent and the sign corresponding to the second operation result are the same as the description in the first detailed path, so a repeated description thereof is omitted. Although not shown in FIG. 6B, the MUX (e.g., the MUX 250 of FIG. 2) may output, as the FMA operation result, the second operation result generated from the second path circuit 230 along the second detailed path in response to the determined exponent difference being greater than or equal to the third threshold value (e.g., ‘2’) and less than the fourth threshold value (e.g., ‘24’).

FIG. 6C describes the generation of the FMA operation result (e.g., mant_23) based on the mantissa (e.g., 0::P_mant) corresponding to the multiplication of the first operand and the second operand and the mantissa (e.g., 00::C_mant) corresponding to the third operand along the third detailed path in the second path circuit 230. The third detailed path may represent a data path for an FMA operation when the exponent difference between the exponent corresponding to the multiplication of the first operand and the second operand and the exponent corresponding to the third operand is greater than or equal to the fourth threshold value (e.g., ‘24’ for FP32).

In the third detailed path, the second path circuit 230 may generate the two's complement for the mantissa (e.g., 00::C_mant) corresponding to the third operand, based on the two's complement generation signal (e.g., the exponent difference information 600). For example, the two's complement generation signal (e.g., the exponent difference information 600) may be determined based on a sign (e.g., the sign 205 of FIG. 2, and hereinafter, referred to as ‘fma_sign’) corresponding to the multiplication of the first operand and the second operand and the exponent difference information 600. The generation of the two's complement is described above in the first detailed path and the second detailed path, so a repeated description thereof is omitted.

In the third detailed path, the second path circuit 230 corresponds to a case in which the exponent difference is a positive number that is greater than or equal to the fourth threshold value (that is, a case in which the exponent corresponding to the third operand is less than the exponent corresponding to the multiplication of the first operand and the second operand), so a mantissa corresponding to the third operand may be determined to be the mantissa to be bit-shifted.

In the third detailed path, the second path circuit 230 may perform a sign extension on the mantissa (e.g., 00::C_mant) corresponding to the third operand so that the mantissa (e.g., 00::C_mant) corresponds to a bit number of a mantissa corresponding to the multiplication of the first operand and the second operand, based on the exponent difference information 600. For example, the bit number of the mantissa corresponding to the multiplication of the first operand and the second operand corresponds to 49 bits, so ‘0’ may be added to the MSB portion of the mantissa (e.g., 00:C_mant) corresponding to 24 bits. For example, the mantissa corresponding to the sign-extended third operand may represent signed_C_mant_49, which is 49 bits. Based on the exponent difference information 600, the second path circuit 230 may select the mantissa (e.g., signed_C_mant_49) corresponding to the sign-extended third operand to be the mantissa to be bit-shifted. The second path circuit 230 may perform a bit shift on the mantissa corresponding to the sign-extended third operand based on a value obtained by subtracting the exponent difference by a predetermined number (e.g., ‘24’) by inputting signed_C_mant_49 selected as the mantissa to be bit-shifted to the alignment shifter. Since the third detailed path corresponds to a case in which the exponent difference is greater than or equal to ‘24,’ in the third detailed path, the mantissa corresponding to the third operand may be placed at the right position (e.g., a 25-th position from the left) compared to a 24-th bit from the left of the mantissa corresponding to the multiplication of the first operand and the second operand. Accordingly, to reduce the size of the shifter (e.g., the alignment shifter), the mantissa corresponding to the sign-extended third operand may be bit-shifted by a value obtained by subtracting the exponent difference by a predetermined number (e.g., ‘24’ corresponding to the first threshold value), and the shifted mantissa (e.g., shifted_input_49) may be generated.

In the third detailed path, the second path circuit 230 may select the unshifted mantissa based on the exponent difference information 600. In the third detailed path, the exponent difference corresponds to a positive number, so the exponent corresponding to the multiplication of the first operand and the second operand may be greater than the exponent corresponding to the third operand. That is, in the third detailed path, the second path circuit 230 shifts a mantissa corresponding to an operand having a smaller exponent, so the mantissa (e.g., 0::P_mant) corresponding to an operand having a large exponent may be determined to be the unshifted mantissa (e.g., unshifted_input_49).

In the third detailed path, the second path circuit 230 may input the shifted mantissa (e.g., shifted_input_49) and the unshifted mantissa (e.g., unshifted_input_49) to the adder and may output Frac [48:24], R:[23], and S [22:0]. The second path circuit 230 may perform a rounding operation (e.g., rounding) on Frac [48:24] based on R:[23] and S [22:0]. In addition, the second path circuit 230 may generate the second operation result (e.g., mant_23) by normalizing (e.g., post-normalizing) the result that is output from the adder. Here, the exponent and the sign corresponding to the second operation result may be the same as the multiplication of the first operand and the second operand. Although not shown in FIG. 6C, the MUX (e.g., the MUX 250 of FIG. 2) may output, as the FMA operation result, the second operation result generated from the second path circuit 230 along the third detailed path in response to the determined exponent difference being greater than or equal to the fourth threshold value (e.g., ‘24’) that is greater than the third threshold value (e.g., ‘2’).

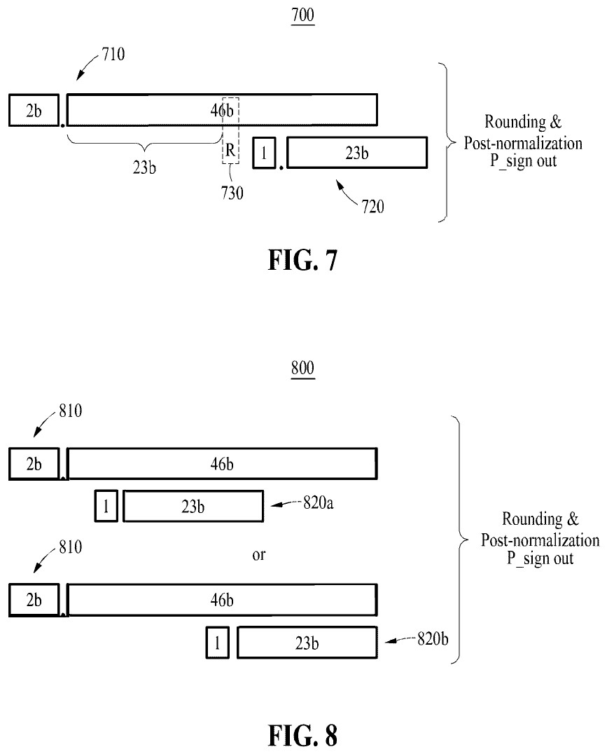

FIGS. 7 to 9 illustrate examples 700, 800, and 900 in which an FMA circuit selects, as an FMA operation result, a second operation result generated based on a second path circuit, according to an embodiment. The examples 700, 800, and 900 of FIGS. 7 to 9 are described based on a case in which first to third operands are FP32.

The example 700 of FIG. 7 shows a positional relationship between a mantissa 710 and a mantissa 720 to perform an FMA operation between the mantissa 710 corresponding to the multiplication of the first operand and the second operand and the mantissa 720 corresponding to the third operand along the first detailed path of FIG. 6A. For example, the example 700 shows a case in which an exponent difference between an exponent corresponding to the multiplication of the first operand and the second operand and an exponent corresponding to the third operand is greater than or equal to a fourth threshold value (e.g., ‘24’). As shown in the example 700, the exponent corresponding to the third operand is less than the exponent corresponding to the multiplication of the first operand and the second operand, so the mantissa 720 may be bit-shifted in the first detailed path. Here, when operands subject to the FMA operation are FP32, the number corresponding to a mantissa of FP32 is 23 bits, so it may be meaningful when the mantissa 720 is summed with the mantissa 710 only when the number of the mantissa 720 to be bit-shifted is between ‘24’ and ‘46.’ Accordingly, the FMA operation performed along the first detailed path may be implemented using the maximum 23-bit shifter (e.g., the alignment shifter of FIGS. 6A to 6C). In the example 700, the FMA circuit may determine a 24-bit position 730 to be the rounding bit R and may perform a rounding operation and a normalization task after adding the mantissa 710 to the mantissa 720.

The example 800 of FIG. 8 shows a positional relationship between a mantissa 810 and mantissas 820a and 820b to perform an FMA operation between the mantissa 810 corresponding to the multiplication of the first operand and the second operand and the mantissas 820a and 820b corresponding to the third operand along the second detailed path of FIG. 6B. For example, the example 800 shows the positional relationship between the mantissa 810 and the mantissas 820a and 820b when the exponent difference between the exponent corresponding to the multiplication of the first operand and the second operand and the exponent corresponding to the third operand is greater than or equal to a third threshold value (e.g., ‘2’) and less than a fourth threshold value (e.g., ‘24’). For example, the example 800 shows the positional relationship between the mantissa 810 and the mantissa 820a when the exponent difference between the exponent corresponding to the multiplication of the first operand and the second operand and the exponent corresponding to the third operand is ‘2.’ In another example, the example 800 shows the positional relationship between the mantissa 810 and the mantissa 820b when the exponent difference between the exponent corresponding to the multiplication of the first operand and the second operand and the exponent corresponding to the third operand is ‘23.’

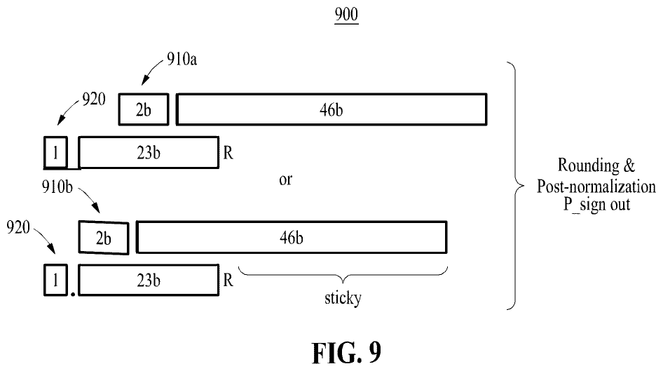

The example 900 of FIG. 9 shows a positional relationship between mantissas 910a and 910b and a mantissa 920 to perform an FMA operation between the mantissas 910a and 910b corresponding to the multiplication of the first operand and the second operand and the mantissas 920 corresponding to the third operand along the third detailed path of FIG. 6C. For example, the example 900 shows the positional relationship between the mantissas 910a and 910b and the mantissa 920 when the exponent difference between the exponent corresponding to the multiplication of the first operand and the second operand and the exponent corresponding to the third operand is greater than or equal to the first threshold value (e.g., ‘−24’) and less than a second threshold value (e.g., ‘−2’).

FIG. 10 is a block diagram illustrating a structure of a third path circuit, according to an embodiment.

As described above with reference to FIG. 2, the third path circuit 240 according to an embodiment may correspond to a circuit for implementing a path (e.g., a close path or a short path) that performs an FMA operation when the exponent difference between an exponent corresponding to the multiplication of a first operand and a second operand and an exponent corresponding to a third operand is greater than or equal to a second threshold value and less than a third threshold value. The third path circuit 240 may generate a third operation result (e.g., mant_23) based on a mantissa (e.g., 00::P_mant) corresponding to the multiplication of the first operand and the second operand and a mantissa (e.g., 000::C_mant) corresponding to the third operand. The third operation result (e.g., mant_23) may include a mantissa corresponding to ‘the first operand×the second operand+the third operand.’ Although not shown in FIG. 10, a MUX (e.g., the MUX 250 of FIG. 2) may output the third operation result (e.g., mant_23) as the FMA operation result in response to the determined exponent difference being greater than or equal to the second threshold value and less than the third threshold value.

The third path circuit 240 may be implemented as a digital circuit including a plurality of MUXs, an adder of 29 bits, a concat (e.g., a logic circuit), a two's complement generator (e.g., 2's comp) 1030 (e.g., a logic circuit), a leading one detector (LOD) 1040 (e.g., a logic circuit) of 26 bits, and normalize shifters 1050 of 49 bits. The LOD 1040 may be used to find the position of the most significant ‘1’ in a binary number. The concat may be used to join two or more binary numbers.

The third path circuit 240 may generate a two's complement of the mantissa (e.g., 00::P_mant) corresponding to the multiplication of the first operand and the second operand, based on a sign 1002 (e.g., P_sign) corresponding to the multiplication of the first operand and the second operand. For example, when the sign 1002 is a negative number, the third path circuit 240 may generate signed_P_mant corresponding to the two's complement of the mantissa (e.g., 00::P_mant). In addition, the third path circuit 240 may generate a two's complement of the mantissa (e.g., 000::C_mant) corresponding to the third operand, based on a sign 1001 (e.g., C_sign) corresponding to the third operand. For example, the third path circuit 240 may generate the two's complement of the mantissa (e.g., 000::C_mant) when the sign 1001 is a negative number. That is, based on the signs 1001 and 1002, the third path circuit 240 may use the mantissas (e.g., 00::P_mant and 000::C_mant) for the FMA operation when each of the signs 1001 and 1002 is a positive number and may use a two′ complement of a mantissa corresponding to a sign, which is a negative number, for the FMA operation when at least one of the signs 1001 and 1002 is a negative number. The mantissas (e.g., 00::P_mant and 000::C_mant) determined according to the signs 1001 and 1002 may be referred to as signed_c_mant:2′b0 and signed_P_mant, respectively.

The third path circuit 240 may perform, by the exponent difference, a bit shift on a mantissa of an operand corresponding to a lesser value among the exponent corresponding to the multiplication of the first operand and the second operand and the exponent corresponding to the third operand. For example, the third path circuit 240 may perform a bit shift on the mantissa of the operand with the smaller exponent, based on the exponent difference between the product of the first and second operands and the third operand. For example, the third path circuit 240 may shift the mantissas (e.g., signed_c_mant:2′b0 and signed_P_mant) based on exponent differences 1010 and 1020. For example, in the third path circuit 240, when the second threshold value is defined as ‘−2’ and the third threshold value is defined as ‘2,’ the exponent difference between the exponent corresponding to the multiplication of the first operand and the second operand and the exponent corresponding to the third operand may correspond to one of ‘−2,’ ‘−1,’ and ‘1.’ For example, when the exponent difference 1010 is ‘1,’ the third path circuit 240 may generate, as a shifted mantissa 1011 (e.g., sign_shifted_C_mant_29 bit), a mantissa in which signed_C_mant:2′b0 based on the mantissa (e.g., 000::C_mant) corresponding to the third operand is shifted (e.g., >>1) to the right by ‘1’ and may determine an unshifted mantissa 1021 to be sign_shifted_P_mant[49:21] _29 bit based on signed_P_mant. In another example, when the exponent difference 1020 is ‘−1,’ the third path circuit 240 may generate, as the shifted mantissa (e.g., sign_shifted_P_mant[49:21] _29 bit) 1021, a mantissa in which signed_P_mant based on the mantissa (e.g., 00::P_mant) corresponding to the multiplication of the first operand and the second operand is shifted (e.g., >>1) to the right by ‘l’ and may determine the unshifted mantissa 1011 to be sign_shifted_C_mant_29 bit. That is, based on the exponent differences 1010 and 1020, the third path circuit 240 may shift one of the mantissa corresponding to the third operand or the mantissa corresponding to the multiplication of the first operand and the second operand by up to 2 bits (i.e., by a value corresponding to the exponent difference) and does not shift the remaining mantissas. Hereinafter, the description is mainly provided based on a case in which the exponent differences 1010 and 1020 are ‘1’.

The third path circuit 240 may generate an upper 29-bit addition result (e.g., mant_add_29) of the mantissa corresponding to the third operand and the mantissa corresponding to the multiplication of the first operand and the second operand by inputting the shifted mantissa 1011 and the unshifted mantissa 1021 to the adder.

The third path circuit 240 may generate a 50-bit result (e.g., mant_add_50) by coupling or concatenating the lower 21 bits (e.g., sign_shifted_P_mant[20:0] _21 bit) based on the mantissa corresponding to the multiplication of the first operand and the second operand with an upper 29-bit addition result (e.g., mant_add_29) of the mantissa corresponding to the third operand and the mantissa corresponding to the multiplication of the first operand and the second operand, using the concat.

The third path circuit 240 may generate a two's complement for a 50-bit result through the two's complement generator (e.g., the 2's comp) 1030, based on the MSB of the 50-bit result (e.g., mant_add_50). For example, the third path circuit 240 may generate the two's complement for the 50-bit result (e.g., mant_add_50) using the two's complement generator 1030 when a value of the MSB is ‘1’ (that is, when a value of the MSB indicates a negative number). In another example, the generating of the two's complement may be skipped when a value of the MSB is ‘0’ (that is, when a value of the MSB indicates a positive number). The number generated based on the MSB of the 50-bit result may be referred to as mant_add_signed_50.

The third path circuit 240 may include the LOD 1040 that extracts a bit position value having a bit corresponding to a value of ‘1’ and closest to the MSB in a result obtained by adding a bit-shifted mantissa to the remaining mantissas. For example, the LOD 1040 may extract the bit position value that is closest to the MSB among bits corresponding to the value of ‘1’ from the remaining 49 bits, excluding the MSB, in the 50-bit result referred to as mant_add_signed_50. The LOD 1040 may calculate the number of ‘0’s from the MSB of mant_add_signed_50 to the extracted bit position, based on the extracted bit position value. The LOD 1040 may generate a shift amount for normalization, based on the calculated number of ‘0’s. Here, the shift amount may correspond to the number of bits to shift mant_add_signed_50. The LOD 1040 may normalize an exponent of mant_add_signed_50 by exponent-updating (e.g., exp_update) 1041 by the same number as the generated shift amount.

The third path circuit 240 may include the normalize shifters 1050 that perform a normalization shift on a number based on a result obtained by adding the mantissa 1011 to the mantissa 1021, based on the bit position value extracted from the LOD 1040. The normalize shifters 1050 may normalize the mantissa corresponding to mant_add_signed_50 based on the number of ‘0's from the MSB to the extracted bit position, which is calculated from the LOD 1040. For example, the normalize shifters 1050 may normalize the mantissa corresponding to mant_add_signed_50 so that the integer digit of the mantissa becomes 1 digit. For reference, a condition in which the third path circuit 240 performs the FMA operation may be a condition in which the exponent difference is greater than or equal to the second threshold value and less than the third threshold value. For example, when the second threshold value is ‘−2’ and the third threshold value is ‘2,’ a decimal point positional relationship between the mantissa corresponding to the multiplication of the first operand and the second operand and the mantissa corresponding to the third operand may differ by the maximum of ‘2.’ That is, assuming that two mantissas are subtracted when the decimal points of the two mantissas are similar, the result may be in the form of 0.000000000 . . . 1. Accordingly, a normalization process may be necessary to remove as may ‘0’s as possible before the first ‘1’ that is before the decimal point and leave the effective number. The number shifted by the normalize shifters 1050 may be referred to as mant_add_shifted_50.

The third path circuit 240 may generate the third operation result (e.g., mant_23) by performing a rounding operation and post normalization on mant_add_shifted_50 generated by the normalize shifters 1050.

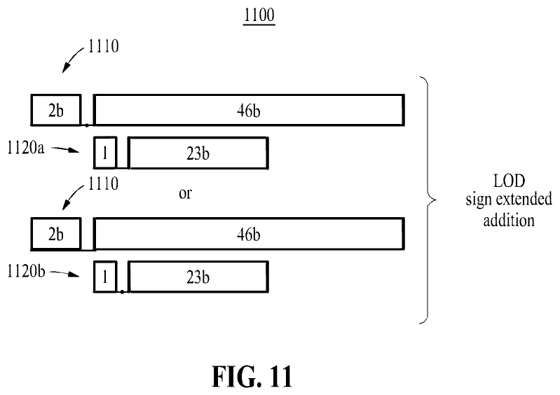

FIG. 11 illustrates an example in which an FMA circuit selects, as an FMA operation result, a third operation result generated based on a third path circuit, according to an embodiment.

In an example 1100 of FIG. 11, the description is based on a case in which first to third operands are FP32.

The example 1100 shows a positional relationship between a mantissa 1110 corresponding to the multiplication of the first operand and the second operand and mantissas 1120a and 1120b corresponding to the third operand to perform an FMA operation through the third path circuit of FIG. 10. For example, the example 1100 shows a case in which an exponent difference between an exponent corresponding to the multiplication of the first operand and the second operand and an exponent corresponding to the third operand is greater than or equal to a second threshold value (e.g., ‘−2’) and less than a third threshold value (e.g., ‘2’). In the example 1100, the positional relationship between the mantissa 1110 and the mantissa 1120a may represent a case in which the exponent difference is ‘1.’ In the example 1100, the positional relationship between the mantissa 1110 and the mantissa 1120b may represent a case in which the exponent difference is ‘−1.’ Although not shown in the example 1100, in the positional relationship between the mantissa 1110 and the mantissa 1120b, a case in which the mantissa 1120b moves to the left by 1 bit may indicate a case in which the exponent difference is ‘−2.’ To sum the mantissa 1110 and the mantissa 1120a or 1120b according to the positional relationship from the case in which the exponent difference is ‘−2’ to ‘1,’ an adder of at least 29 bits (a sign bit of 1 bit+27 bits+a round bit of 1 bit) may be required.

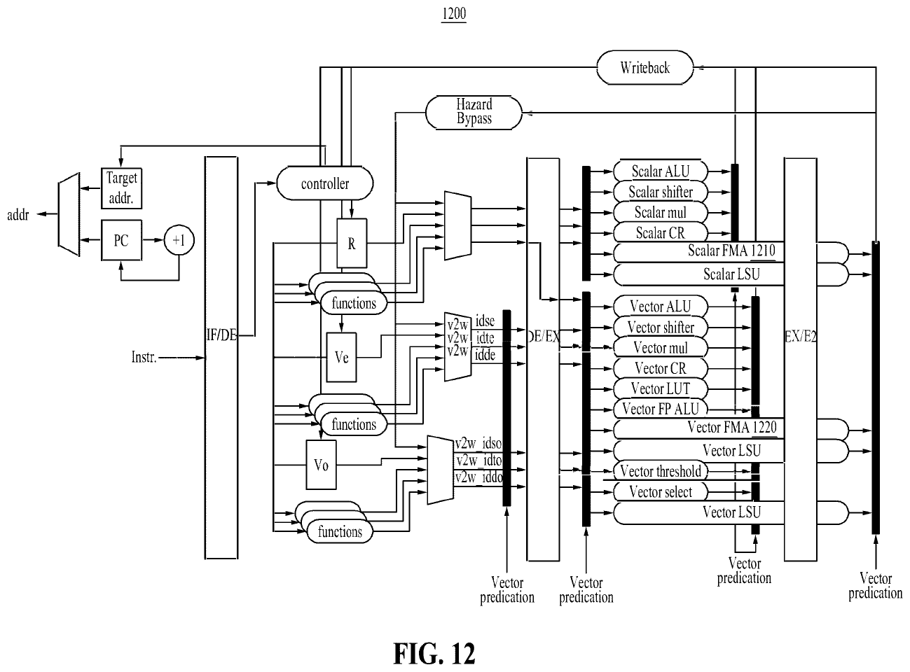

FIG. 12 illustrates a vector processor using an FMA circuit, according to an embodiment.

A vector processor 1200 according to an embodiment may efficiently perform parallel processing on vector data. For example, the vector processor 1200 may perform operations such as an addition, multiplication, multiplication-accumulation, inner product, etc., on multi-dimensional vector data (e.g., a two-dimensional vector, a three-dimensional vector, etc.). The vector processor 1200 may represent a processor for a neural network operation. Specifically, the vector processor 1200 may process a large-scale matrix or a vector operation in parallel in a training and inference process of a machine learning model. In particular, an FMA operation (an FMA or a single multiply-accumulate operation) may represent a unit operation used to calculate the inner product of an input vector and a weight vector at each layer (e.g., an input layer, a hidden layer, and an output layer) of a neural network (e.g., a neural network model). Accordingly, an FMA circuit (or an FMA unit) for an efficient FMA operation may be required when training a machine learning model or a neural network model or inferring with the models, based on the vector processor 1200. The vector processor 1200 according to an embodiment may include the FMA circuit 200 corresponding to FIG. 2. The vector processor 1200 may include the FMA circuit described herein in the form of a scalar FMA operator 1210 and a vector FMA operator 1220 for the FP32 or BF16 operation. When the vector processor 1200 operates, the scalar FMA operator 1210 and the vector FMA operator 1220 may increase the performance of the vector processor 1200 by performing an FMA operation based on the exponent difference on a plurality of input floating points in the FP32 format.

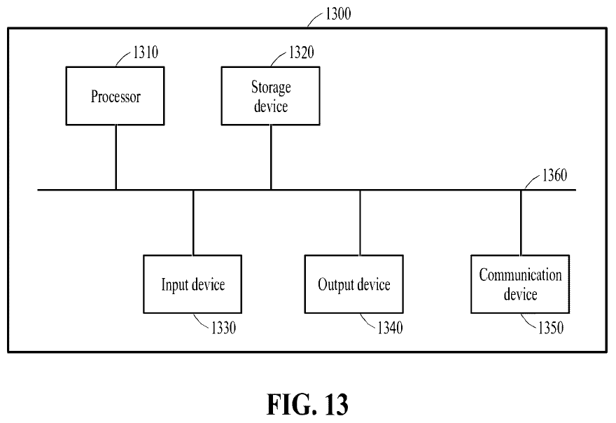

FIG. 13 is a block diagram illustrating a configuration of an electronic device, according to an embodiment.

Referring to FIG. 13, an electronic device 1300 may include, for example, a smartphone, a tablet computer, a wearable device, a netbook, a laptop, a neural network device, etc. The electronic device 1300 may include a processor 1310, a storage device 1320, an input device 1330, an output device 1340, and a communication device 1350. Each component of the electronic device 1300 may communicate with each other via a communication bus 1360. The electronic device 1300 may perform an FMA operation based on the FMA circuit 200 of FIG. 2.

The processor 1310 may control the overall operations of the electronic device 1300 and may execute functions and instructions to be executed in the electronic device 1300. The processor 1310 may include a plurality of processors and the vector processor 1200 of FIG. 12. The processor 1310 may perform one or more operations described above with reference to FIGS. 2 to 12. For example, when the electronic device 1300 trains a stored neural network model, the processor 1310 may perform an FMA operation between an input signal and a weight performed at each layer of the neural network model.

The storage device 1320 may store information that is necessary for the processor 1310 to perform processing operations. For example, the storage device 1320 may store instructions to be executed by the processor 1310 and may store related information while software and/or applications are executed by the electronic device 1300. The storage device 1320 may include random-access memory (RAM), dynamic RAM (DRAM), static RAM (SRAM), or another type of non-volatile memory known in the art.

The input device 1330 may receive an input from a user through a tactile, video, audio, or touch input. For example, the input device 1330 may detect an input from a keyboard, a mouse, a touchscreen, a microphone, a retinal scanner, or a user, and may include any other device configured to transmit the detected input to the electronic device 1300.

The output device 1340 may provide a user with an output of the electronic device 1300 through a visual channel, an auditory channel, or a tactile channel. The output device 1340 may include, for example, a display panel for a liquid crystal display or a light-emitting diode (LED) display and/or an organic light-emitting diode (OLED) display, a touch screen, a speaker, a vibration generator, or any other device that provides the output to the user. The display panel may include a display layer in which hole areas through which external light transmits and pixel areas for outputting a display image are disposed.

The communication device 1350 may communicate with an external device through a wired network or a wireless network. The communication device 1350 may transmit and/or receive data or information to and/or from the external device.

The embodiments described herein may be implemented using a hardware component, a software component, and/or a combination thereof. A processing device (e.g., processor 1310) may be implemented using one or more general-purpose or special-purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an OS and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and/or multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs and/or DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher-level code that may be executed by the computer using an interpreter.

The above-described hardware devices may be configured to act as one or more software modules in order to perform the operations of the above-described embodiments, or vice versa.

As used herein, “A or B,” “at least one of A and B,” “at least one of A or B,” “A, B or C,” “at least one of A, B and C,” and “at least one of A, B, or C,” each of which may include any one of the items listed together in the corresponding one of the phrases, or all possible combinations thereof.

As described above, although the embodiments have been described with reference to the limited drawings, a person skilled in the art may apply various technical modifications and variations based thereon. For example, suitable results may be achieved if the described techniques are performed in a different order, and/or if components in a described system, architecture, device, or circuit are combined in a different manner, or replaced or supplemented by other components or their equivalents. Accordingly, other implementations are within the scope of the following claims.

What is claimed is:

1. A fused multiply-add (FMA) circuit comprising:
a subtractor configured to determine an exponent difference between an exponent corresponding to multiplication of a first operand and a second operand and an exponent corresponding to a third operand;
a multiplier configured to multiply a mantissa corresponding to the first operand and a mantissa corresponding to the second operand to generate a mantissa multiplication result;
a processor configured to generate a plurality of operation results from the mantissa multiplication result and a mantissa corresponding to the third operand, based on a plurality of path circuits respectively corresponding to a plurality of predetermined exponent ranges; and
a multiplexer configured to output, as an FMA operation result, a first operation result selected from among the plurality of operation results in response to the exponent difference belonging to a first exponent range among the predetermined exponent ranges,
wherein a first path circuit of the plurality of path circuits is configured to:
perform one of an increment operation or a decrement operation on the mantissa corresponding to the third operand to generate an updated mantissa, based on a comparison result between a sign corresponding to the multiplication of the first operand and the second operand and a sign corresponding to the third operand; and
provide one of the updated mantissa or the mantissa corresponding to the third operand, as the first operation result.

2. The FMA circuit of claim 1, wherein the first path circuit is configured to:
generate a rounding result of an intermediate operation between the mantissa multiplication result and the mantissa corresponding to the third operand when the exponent difference is in the first exponent range;
generate the first operation result by increasing or decreasing the mantissa corresponding to the third operand when the exponent difference is in the first exponent range and the rounding result is rounding up; and
provide the mantissa corresponding to the third operand as the first operation result when the exponent difference is not in the first exponent range or the rounding result is rounding down.

3. The FMA circuit of claim 1, wherein the multiplexer is configured to output, as the FMA operation result, a second operation result generated by a second path circuit of the plurality of path circuits based on a mantissa corresponding to the multiplication of the first operand and the second operand and the mantissa corresponding to the third operand in response to the exponent difference belonging to a second exponent range among the predetermined exponent ranges,
wherein the second exponent range is greater than or equal to a first threshold value and less than a second threshold value, or greater than or equal to a third threshold value.

4. The FMA circuit of claim 3, wherein the second path circuit is configured to perform a bit shift on a mantissa of an operand corresponding to an exponent having a lesser value among the exponent corresponding to the multiplication of the first operand and the second operand and the exponent corresponding to the third operand, based on the exponent difference.

5. The FMA circuit of claim 3, wherein, in response to the exponent difference being greater than or equal to a fourth threshold value that is greater than the third threshold value, the multiplexer is configured to output, as the FMA operation result, the second operation result generated by the second path circuit based on performing a sign extension on the mantissa corresponding to the third operand to generate a sign-extended mantissa so that the mantissa corresponding to the third operand corresponds to a bit number of a mantissa corresponding to the multiplication of the first operand and the second operand and performing a bit shift on the sign-extended mantissa based on a value obtained by subtracting the sign-extended mantissa from the exponent difference by a predetermined number.

6. The FMA circuit of claim 3, wherein, in response to the exponent difference being greater than or equal to the third threshold value and less than a fourth threshold value, the multiplexer is configured to output, as the FMA operation result, the second operation result generated by the second path circuit based on performing zero-padding on the mantissa corresponding to the third operand to generate a zero-padded mantissa and performing a bit shift on the zero-padded mantissa based on the exponent difference.

7. The FMA circuit of claim 3, wherein, in response to the exponent difference being greater than or equal to the first threshold value and less than the second threshold value, the multiplexer is configured to output, as the FMA operation result, the second operation result generated by the second path circuit based on performing a bit shift on the mantissa corresponding to the multiplication of the first operand and the second operand by a number of sign inversions of the exponent difference.

8. The FMA circuit of claim 1, wherein, in response to the exponent difference belonging to a third exponent range among the plurality of predetermined exponent ranges, the multiplexer is configured to output, as the FMA operation result, a third operation result generated by a third path circuit of the plurality of path circuits based on a mantissa corresponding to the multiplication of the first operand and the second operand and the mantissa corresponding to the third operand,
wherein the third exponent range is greater than or equal to a second threshold value and less than a third threshold value.

9. The FMA circuit of claim 8, wherein the third path circuit is configured to perform, based on the exponent difference, a bit shift on a mantissa of an operand corresponding to a lesser value among the exponent corresponding to the multiplication of the first operand and the second operand and the exponent corresponding to the third operand to generate a bit-shifted mantissa,
wherein the third path circuit comprises:
a leading one detector (LOD) configured to extract a bit position value having a bit corresponding to a value of ‘1’ and closest to a most significant bit (MSB), in an addition result of the bit-shifted mantissa and remaining mantissas; and
a normalize shifter configured to perform a normalization shift on the addition result based on the extracted bit position value.

10. The FMA circuit of claim 5, wherein the second threshold value is greater than the first threshold value, and the third threshold value is greater than the second threshold value,
wherein the first threshold value and the fourth threshold value are defined based on a bit-precision of at least one of the first to third operands.

11. A fused multiply-add (FMA) operation method comprising:
determining an exponent difference between an exponent corresponding to multiplication of a first operand and a second operand and an exponent corresponding to a third operand;
multiplying a mantissa corresponding to the first operand and a mantissa corresponding to the second operand to generate a mantissa multiplication result;
generating a plurality of operation results from the mantissa multiplication result and a mantissa corresponding to the third operand, based on a plurality of path circuits respectively corresponding to a plurality of predetermined exponent ranges; and
outputting, as an FMA operation result, a first operation result selected from among the plurality of operation results in response to the exponent difference belonging to a first exponent range among the predetermined exponent ranges,
wherein the generating of the plurality of operation results comprises:
performing one of an increment operation or a decrement operation on the mantissa corresponding to the third operand to generate an updated mantissa, based on a comparison result between a sign corresponding to the multiplication of the first operand and the second operand and a sign corresponding to the third operand; and
providing one of the updated mantissa or the mantissa corresponding to the third operand, as the first operation result.

12. The FMA operation method of claim 11, wherein the generating of the plurality of operation results comprises:
generating a rounding result of an intermediate operation between the mantissa multiplication result and the mantissa corresponding to the third operand when the exponent difference is in the first exponent range;
generating the first operation result by increasing or decreasing the mantissa corresponding to the third operand when the exponent difference is in the first exponent range and the rounding result is rounding up; and
providing the mantissa corresponding to the third operand as the first operation result when the exponent difference is not in the first exponent range or the rounding result is rounding down.

13. The FMA operation method of claim 11, further comprising:
generating a second operation result based on a mantissa corresponding to the multiplication of the first operand and the second operand and the mantissa corresponding to the third operand; and
outputting the generated second operation result as the FMA operation result in response to the exponent difference belonging to a second exponent range among the predetermined exponent ranges,
wherein the second exponent range is greater than or equal to a first threshold value and less than a second threshold value, or greater than or equal to a third threshold value.

14. The FMA operation method of claim 13, wherein the generating of the second operation result comprises performing a bit shift on a mantissa of an operand corresponding to an exponent having a lesser value among the exponent corresponding to the multiplication of the first operand and the second operand and the exponent corresponding to the third operand, based on the determined exponent difference.

15. The FMA operation method of claim 13, wherein the outputting of the generated second operation result as the FMA operation result comprises:
performing a sign extension on the mantissa corresponding to the third operand to generate a sign-extended mantissa so that the mantissa corresponding to the third operand corresponds to a bit number of the mantissa corresponding to the multiplication of the first operand and the second operand;
generating the second operation result based on performing a bit shift on the sign-extended mantissa based on a value obtained by subtracting the sign-extended mantissa from the exponent difference by a predetermined number; and
outputting the generated second operation result as the FMA operation result in response to the exponent difference being greater than or equal to a fourth threshold value that is greater than the third threshold value.

16. The FMA operation method of claim 13, wherein the outputting of the generated second operation result as the FMA operation result comprises:
performing zero-padding on the mantissa corresponding to the third operand to generate a zero-padded mantissa;
generating the second operation result based on performing a bit shift on the zero-padded mantissa by the exponent difference; and
outputting the generated second operation result as the FMA operation result in response to the exponent difference being greater than or equal to the third threshold value and less than a fourth threshold value.

17. The FMA operation method of claim 13, wherein the outputting of the generated second operation result as the FMA operation result comprises:
generating the second operation result based on performing a bit shift on the mantissa corresponding to the multiplication of the first operand and the second operand by a number of sign inversions of the exponent difference; and
outputting the generated second operation result as the FMA operation result in response to the exponent difference being greater than or equal to the first threshold value and less than the second threshold value.

18. The FMA operation method of claim 11, further comprising:
generating a third operation result by a third path circuit of the plurality of path circuits based on a mantissa corresponding to the multiplication of the first operand and the second operand and the mantissa corresponding to the third operand; and
outputting the generated third operation result as the FMA operation result in response to the exponent difference belonging to a third exponent range among the predetermined exponent ranges,
wherein the predetermined third exponent range is greater than or equal to a second threshold value and less than a third threshold value.

19. The FMA operation method of claim 18, wherein the generating of the third operation result comprises:
performing a bit shift on a mantissa of an operand corresponding to a lesser value among the exponent corresponding to the multiplication of the first operand and the second operand and the exponent corresponding to the third operand to generate a bit-shifted mantissa, based on the exponent difference;
extracting a bit position value having a bit corresponding to a value of ‘1’ and closest to a most significant bit (MSB), in an addition result of the bit-shifted mantissa and remaining mantissas; and
performing a normalization shift on the addition result based on the extracted bit position value.

20. A non-transitory computer-readable storage medium storing instructions that, when executed by a processor, cause the processor to perform the FMA operation method of claim 11.
